(19) United States
(12) Patent Application Publication
(10) Pub. No.: US 2024/0056690 A1
(43) Pub. Date: Feb. 15, 2024

(54) IMAGING APPARATUS

(71) Applicant: Sony Semiconductor Solutions Corporation, Kanagawa (JP)

(72) Inventors: Junya Mizutani, Tokyo (JP); Satomi Kawase, Tokyo (JP)

(21) Appl. No.: 18/258,033

(22) PCT Filed: Nov. 16, 2021
(86) PCT No.: PCT/JP2021/042126

§ 371 Date: Jun. 16, 2023

(30) Foreign Application Priority Data
Dec. 23, 2020 (JP) 2020-213201

(51) Int. Cl. H04N 23/73; H04N 25/534; H04N 23/12; H04N 23/71

(52) U.S. Cl. CPC H04N 23/73; H04N 25/534; H04N 23/12; H04N 23/71

(57) ABSTRACT

An imaging apparatus according to the present disclosure includes a multi-spectral sensor that outputs multiple wavelength signals, a detection circuit that detects a luminance signal in accordance with a spectral characteristic of a desired object on the basis of a detection signal generated using the multiple wavelength signals outputted from the multi-spectral sensor, and a control circuit that performs exposure control in accordance with the spectral characteristic of the desired object on the basis of a detection value of the detection circuit.

### TECHNICAL FIELD

The present disclosure relates to an imaging apparatus that performs multi-spectral imaging.

### BACKGROUND ART

An imaging apparatus configured to perform multi-spectral imaging has been developed (refer to PTL 1 to PTL 3). The multi-spectral imaging is configured to perform single time of exposure to obtain an multi-spectral image using a larger number of wavelength ranges than RGB sensor imaging using red (R), green (G), and blue (B) imaging wavelengths. Meanwhile, in general, a single wavelength range is used in auto exposure (AE) control.

### CITATION LIST

### Patent Literature

PTL 1: Japanese Unexamined Patent Application Publication No. 2018-98341
PTL 2: Japanese Unexamined Patent Application Publication No. 2020-115640
PTL 3: Japanese Unexamined Patent Application Publication No. 2007-127657

### SUMMARY OF THE INVENTION

When imaging of multiple objects having a large illuminance difference is performed, for example, exposure control using only a single wavelength range finds it difficult to achieve correct exposure of a desired object. As a result, an image thus obtained may be saturated, resulting in overexposure or black defects of the image, for example.

It is desirable to provide an imaging apparatus that makes it possible to perform correct exposure.

An imaging apparatus according to one embodiment of the present disclosure includes a multi-spectral sensor that outputs multiple wavelength signals, a detection circuit that detects a luminance signal in accordance with a spectral characteristic of a desired object on the basis of a detection signal generated using the multiple wavelength signals outputted from the multi-spectral sensor, and a control circuit that performs exposure control in accordance with the spectral characteristic of the desired object on the basis of a detection value of the detection circuit.

The imaging apparatus according to one embodiment of the present disclosure performs the exposure control on the basis of a detection value in accordance with the spectral characteristic of the desired object.

### BRIEF DESCRIPTION OF DRAWINGS

FIG. 1 is a block diagram schematically illustrating a configuration example of an imaging apparatus according to a first embodiment of the present disclosure.

FIG. 2 is an explanatory diagram schematically illustrating linear matrix processing in the imaging apparatus according to the first embodiment.

FIG. 3 is a flowchart illustrating an exemplary processing operation flow of exposure control by the imaging apparatus according to the first embodiment.

FIG. 4 is an explanatory diagram illustrating examples of objects to be subjected to imaging by the imaging apparatus according to the first embodiment.

FIG. 5 is an explanatory diagram illustrating exemplary sensor spectral sensitivity and exemplary spectral reflection characteristics of objects.

FIG. 6 is a block diagram schematically illustrating a configuration example of an imaging apparatus according to a modification example of the first embodiment.

FIG. 7 is a block diagram schematically illustrating a configuration example of an imaging apparatus according to a second embodiment.

FIG. 8 is an explanatory diagram illustrating exemplary spectral ratios of objects and exemplary spectral reflection characteristics of the objects.

FIG. 9 is a flowchart illustrating an exemplary processing operation flow of exposure control by the imaging apparatus according to the second embodiment.

FIG. 10 is an explanatory diagram illustrating multiple exemplary ratio spaces.

FIG. 11 is a block diagram schematically illustrating a configuration example of an imaging apparatus according to a modification example of the second embodiment.

FIG. 12 is a block diagram schematically illustrating a configuration example of an imaging apparatus according to a third embodiment.

FIG. 13 is a flowchart illustrating an exemplary processing operation flow of exposure control by the imaging apparatus according to the third embodiment.

FIG. 14 is a block diagram schematically illustrating a configuration example of an imaging apparatus according to a modification example of the third embodiment.

FIG. 15 is a block diagram schematically illustrating a configuration example of an imaging apparatus according to a fourth embodiment.

FIG. 16 is a flowchart illustrating an exemplary processing operation flow of exposure control by the imaging apparatus according to the fourth embodiment.

FIG. 17 is a block diagram schematically illustrating a configuration example of an imaging apparatus according to Modification Example 1 of the fourth embodiment.

FIG. 18 is a block diagram schematically illustrating a configuration example of an imaging apparatus according to Modification Example 2 of the fourth embodiment.

FIG. 19 is a block diagram schematically illustrating a configuration example of an imaging apparatus according to a fifth embodiment.

FIG. 20 is a flowchart illustrating an exemplary overall processing operation flow of exposure control by the imaging apparatus according to the fifth embodiment.

FIG. 21 is a flowchart illustrating an exemplary processing operation flow of the exposure control by the imaging apparatus according to the fifth embodiment.

FIG. 22 is a flowchart subsequent to FIG. 21.

FIG. 23 is a flowchart illustrating an exemplary operation flow of a process of blending detection values by the imaging apparatus according to the fifth embodiment.

FIG. 24 is an explanatory diagram illustrating example captured images obtained through time division imaging by an imaging apparatus according to a sixth embodiment.

FIG. 25 is a timing chart illustrating an exemplary imaging operation involving no time division imaging by the imaging apparatus according to the sixth embodiment.

FIG. 26 is a timing chart illustrating an exemplary imaging operation involving time division imaging by the imaging apparatus according to the sixth embodiment.

### MODES FOR CARRYING OUT THE INVENTION

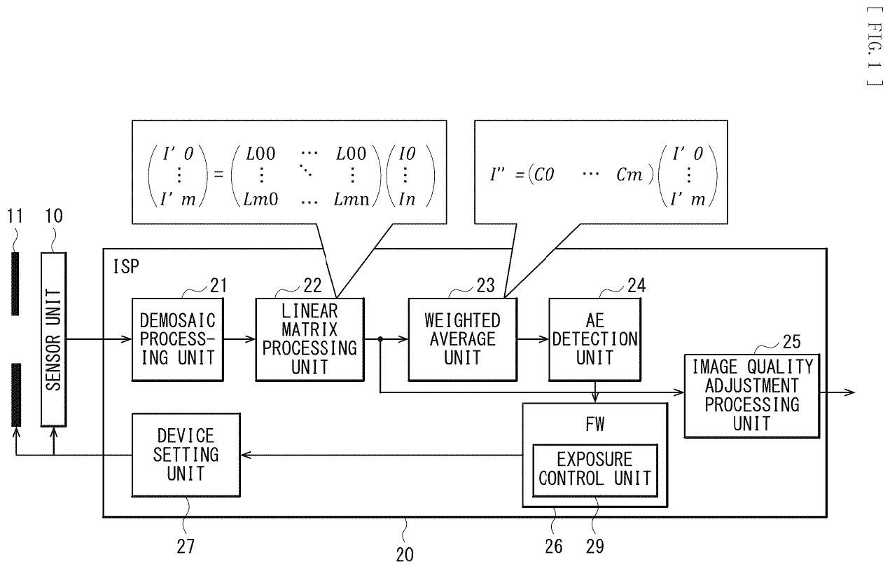

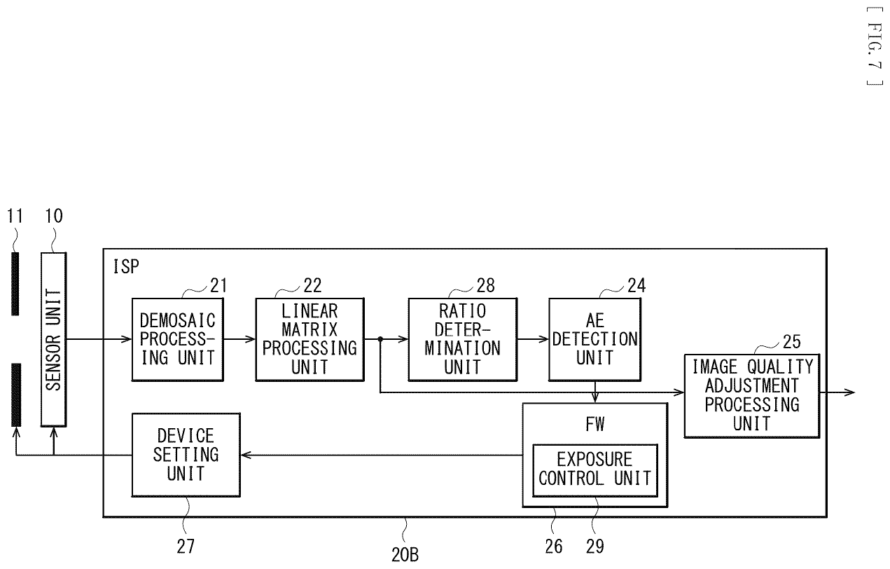

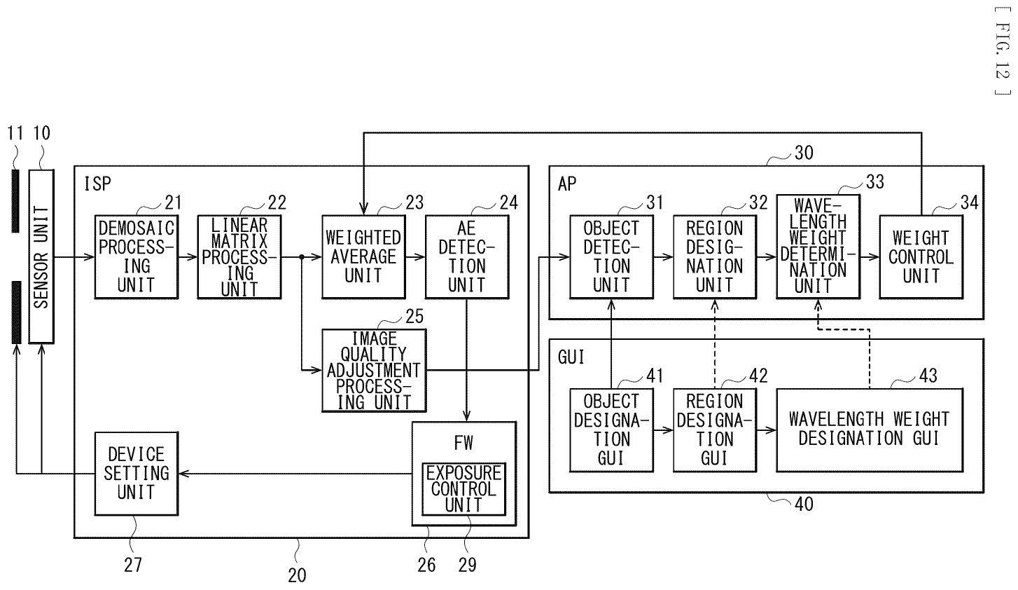

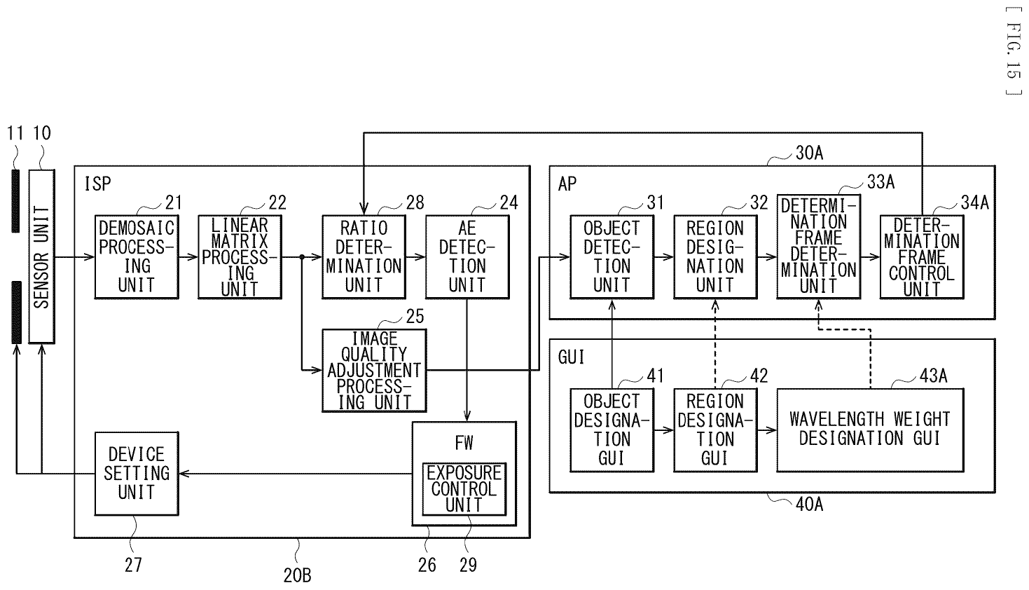

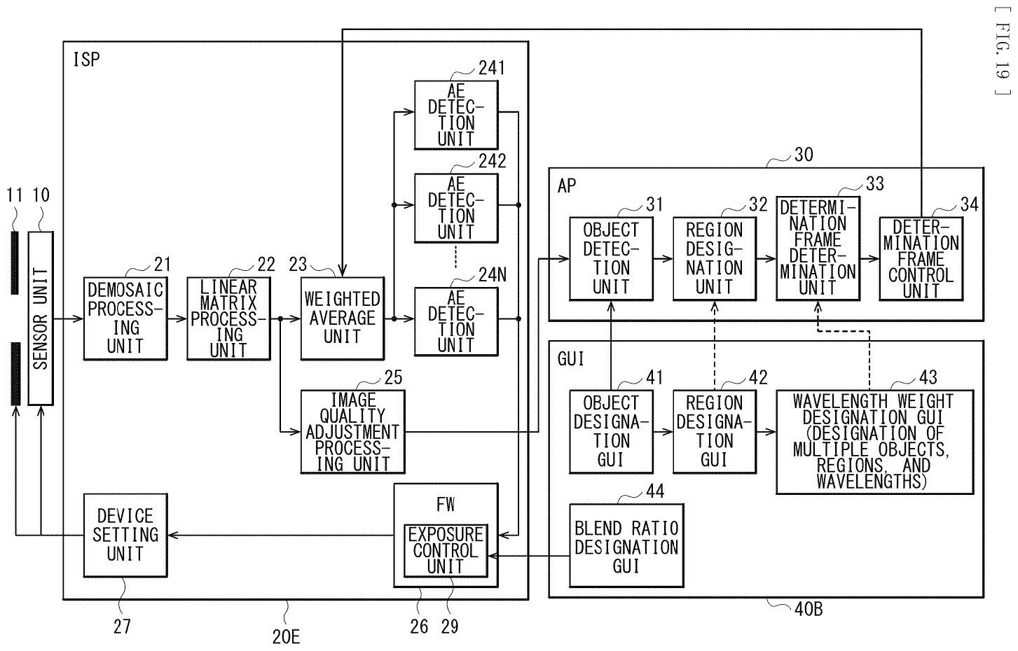

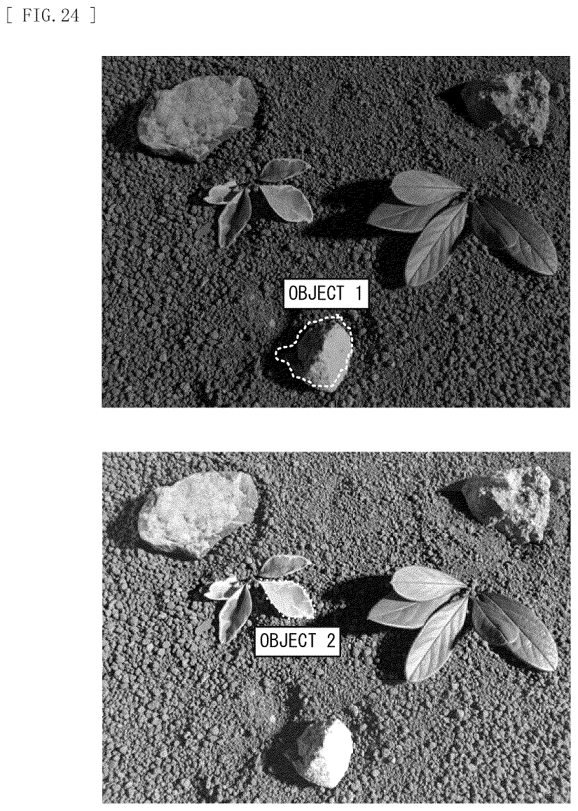

In the following, some embodiments of the present disclosure are described in detail with reference to the drawings. It is to be noted that the description is given in the following order.
1. First Embodiment (Imaging Apparatus Including Weighted average unit) (FIGS. 1 to 6)
1.1 Configuration
1.2 Operation
1.3 Modification Example
1.4 Effect
2. Second Embodiment (Imaging Apparatus Including Ratio Determination Unit) (FIGS. 7 to 11)
2.1 Configuration
2.2 Operation
2.3 Modification Example
2.4 Effect
3. Third Embodiment (Imaging Apparatus Including Weight Control Unit Controlling Weight Coefficient Used in Weighted average unit) (FIGS. 12 to 14)
3.1 Configuration
3.2 Operation
3.3 Modification Example
3.4 Effect
4. Fourth Embodiment (Imaging Apparatus Including Determination Frame Control Unit Controlling Determination Frame Used in Ratio Determination Unit) (FIGS. 15 to 18)
4.1 Configuration
4.2 Operation
4.3 Modification Example
4.4 Effect
5. Fifth Embodiment (Imaging Apparatus Including Multiple AE Detection Units) (FIGS. 19 to 23)
5.1 Configuration
5.2 Operation
5.3 Effect
6. Sixth Embodiment (Imaging Apparatus Performing Time Division Imaging) (FIGS. 24 to 26)
6.1 Configuration
6.2 Operation
6.3 Effect
7. Other Embodiments

### 1. First Embodiment

### 1.1 Configuration

FIG. 1 schematically illustrates a configuration example of an imaging apparatus according to a first embodiment of the present disclosure.

The imaging apparatus according to the first embodiment includes a sensor unit 10, a diaphragm 11, and an image signal processor (ISP) 20.

The sensor unit 10 outputs a pixel signal corresponding to incident light incident through the diaphragm 11 and a non-illustrated imaging lens. The sensor unit 10 includes a multi-spectral sensor that outputs multiple wavelength signals as the pixel signals. The multi-spectral sensor includes, for example, a photoelectric conversion element such as a photodiode, and includes multiple pixels. The multi-spectral sensor is, for example, a solid-state imaging device such as a charge coupled device (CCD) or a complementary metal oxide semiconductor (CMOS). The sensor unit 10 performs A/D conversion of the pixel signals received from the multi-spectral sensor and outputs RAW image data based on the pixel signals.

The multi-spectral sensor outputs, as the multiple wavelength signals, signals in four or more wavelength ranges among red (R), green (G), blue (B), yellow (Y), magenta (M), cyan (C), ultraviolet (UV), and near-infrared (NIR) wavelength ranges, for example.

The ISP 20 includes a demosaic processing unit 21, a linear matrix processing unit 22, a weighted average unit 23, an auto exposure (AE) detection unit 24, an image quality adjustment processing unit 25, firmware (FW) 26, and a device setting unit 27.

The demosaic processing unit 21 conducts demosaic processing on the RAW image data outputted from the sensor unit 10 to thereby generate a luminance plane image having data on multiple wavelength signals per pixel. The linear matrix processing unit 22 is a linear matrix processing circuit that conducts liner matrix processing on the multiple wavelength signals.

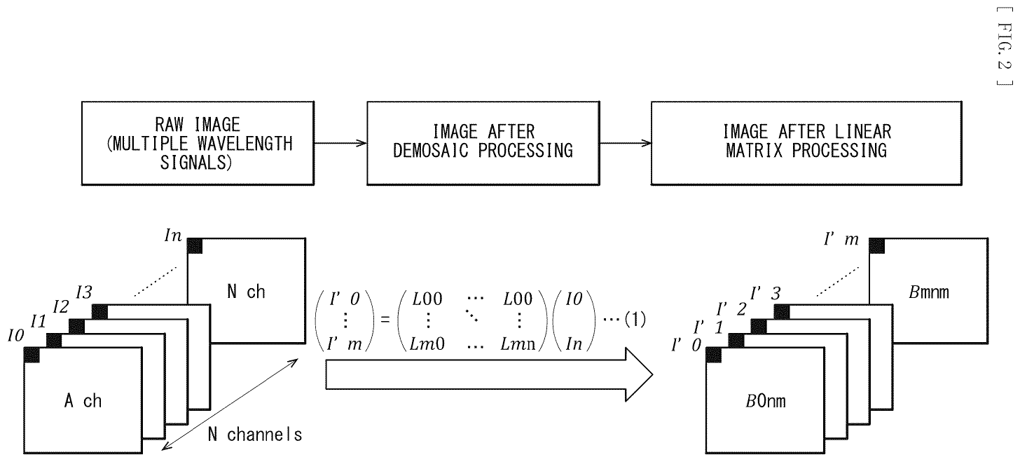

FIG. 2 schematically illustrates the linear matrix processing by the imaging apparatus according to the first embodiment.

In the example illustrated in FIG. 2, the RAW image data includes multiple N-channels wavelength signals. In the example illustrated in FIG. 2, the multiple wavelength signals constituting the N-channel luminance plane image have luminance I0, I1, I2, I3, to In, respectively. The linear matrix processing unit 22 conducts a matrix operation represented by Expression (1) in FIG. 2, for example, on the multiple wavelength signals after the demosaic processing to thereby generate multiple wavelength signals in narrow ranges obtained by dividing the wavelength resolution into a larger number of ranges than those in the RAW image data. In the example illustrated in FIG. 2, multiple wavelength signals constituting an M-channel luminance plane image are generated in a greater number than those of the N-channel luminance place image. The multiple M-channel wavelength signals have luminance I′0, I′1, I′2, I3, to Im (m>n), respectively.

The weighted average unit 23 is a weighted average circuit that calculates a weighted average signal by conducting weighted averaging of the multiple wavelength signals after the linear matrix processing is performed by the linear matrix processing unit 22. For example, as illustrated in FIG. 1, weight coefficients corresponding to the respective luminance I′0, I′1, I′2, I3 to Im of the multiple wavelength signals outputted from the linear matrix processing unit 22 are represented by C0, C1, C2, C3 to Cm, respectively. In addition, luminance after the weighted averaging is represented by I″. The weight coefficients are values set to the respective wavelengths in accordance with a spectral characteristic of a desired object. The weighted average unit 23 generates the calculate weighted average signal as a detection signal, and outputs the detection signal to the AE detection unit 24.

The AE detection unit 24 is a detection circuit that detects a luminance signal in accordance with the spectral characteristic of the desired object on the basis of the detection signal generated using the multiple wavelength signals. The AE detection unit 24 detects the luminance signal in accordance with the spectral characteristic of the desired object on the basis of the weighted average signal generated as the detection signal by the weighted average unit 23.

The FW 26 includes an exposure control unit 29. The exposure control unit 29 is a control circuit that performs exposure control in accordance with the spectral characteristic of the desired object on the basis of a detection value detected by the AE detection unit 24.

The exposure control unit 29 performs the exposure control in accordance with the spectral characteristic of the desired object by controlling the sensor unit 10 and the diaphragm 11 via the device setting unit 27. The settings of the exposure control made by the device setting unit 27 may be all or at least one of a shutter setting, a gain setting, and an aperture setting. The exposure control by the exposure control unit 29 is independent of a device configuration relevant to the exposure control.

The image quality adjustment processing unit 25 conducts various kinds of image adjustment processing on the multiple wavelength signals after the linear matrix processing and outputs the resultant signals as a captured image.

### 1.2 Operation

For example, in the AE control performed by an RGB sensor, the AE detection is generally performed by generating a Y (luminance) image in which RGB signals are blended in a ratio in accordance with a human visual property. In contrast, the multi-spectral sensor is used for a sensing application. Accordingly, the imaging apparatus according to the first embodiment performs the AE detection by generating the luminance signal through not only weighting of the multiple wavelength signals in accordance with the human visual property but also weighting of the multiple wavelength signals in accordance with the desired object. This achieves the AE control further dedicated to the desired object. The imaging apparatus according to the first embodiment makes it possible to achieve the AE control dedicated to a desired object by controlling a signal ratio of each wavelength to be used in the AE control among various wavelength signals measured by the multi-spectral sensor in accordance with the desired object. Further, the imaging apparatus according to the first embodiment limits the wavelength of a luminance signal to be detected by the AE detection unit 24 in accordance with the spectral characteristic of the desired object to thereby correct appropriate exposure of the desired object.

The imaging apparatus according to the first embodiment achieves the AE control dedicated to the luminance of a desired object by detecting the result of weighted averaging of the luminance in the narrow wavelength ranges. In this case, the setting value of a weight coefficient for weighted averaging is determined in accordance with the spectral characteristic of the desired object. Accordingly, even when imaging of multiple objects having different spectral reflection characteristics is performed, for example, it is possible to achieve the AE control dedicated to the desired object.

The setting of a weight coefficient to each wavelength in the weighted average unit 23 is performed by, for example, a method of preliminarily designating any setting value determined by a user in accordance with the spectral characteristic of the desired object. This achieves the setting of a weight coefficient with a minimum configuration (in a low cost).

Alternatively, the setting of a weight coefficient to each wavelength in the weighted average unit 23 may be performed through a dynamical determination based on a captured image captured by the sensor unit 10 as in a third embodiment (FIG. 12) to be described later. In this case, the user is allowed to set the weight coefficient through a simple operation in accordance with a use case.

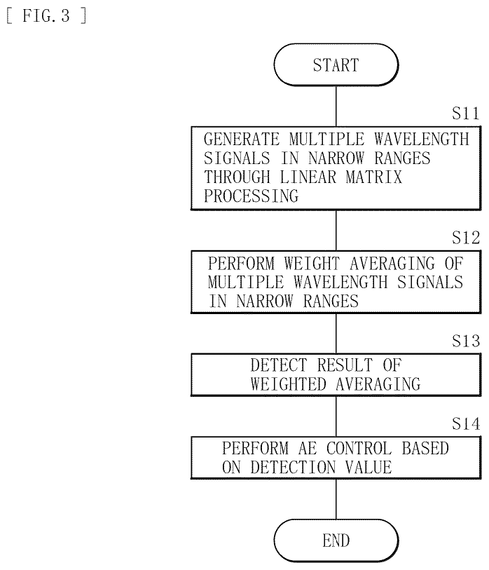

FIG. 3 is a flowchart illustrating an exemplary processing operation flow of the exposure control of the imaging apparatus according to the first embodiment.

First, the linear matrix processing unit 22 generates multiple wavelength signals in narrow ranges through linear matrix processing (Step S11). Thereafter, the weighted average unit 23 performs weighted averaging of the multiple wavelength signals in the narrow ranges (Step S12). Thereafter, the AE detection unit 24 detects the result of the weighted averaging (Step S13). Thereafter, the exposure control unit 29 performs the AE control on the basis of the detection value (Step S14).

### Specific Example

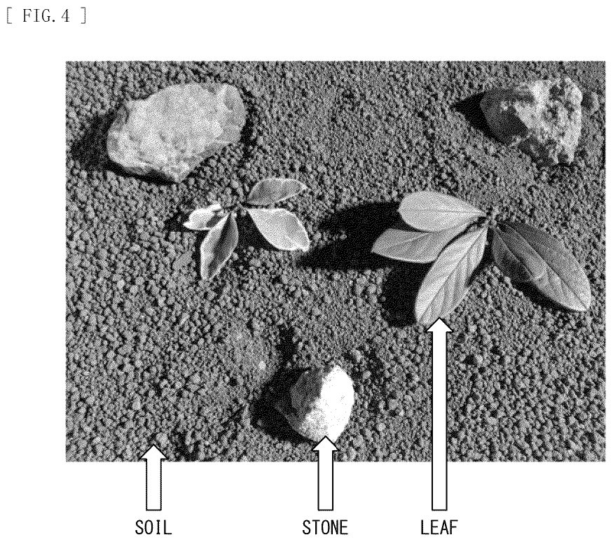

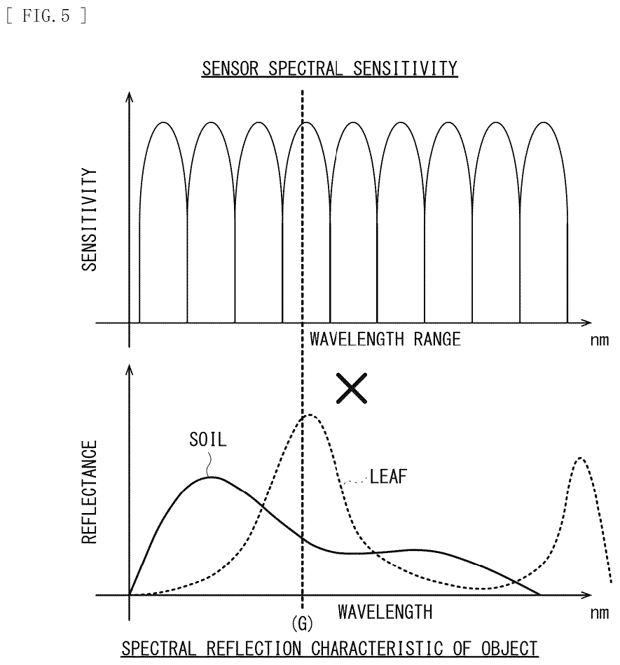

FIG. 4 illustrates examples of objects to be subjected to imaging by the imaging apparatus according to the first embodiment. FIG. 5 illustrates exemplary sensor spectral sensitivity and exemplary spectral reflection characteristics of the objects.

In a use case in which objects including a leaf, soil, and a stone as illustrated in FIG. 4, for example, if imaging of only the leaf is wanted to be performed at correct exposure, the weighted average unit 23 sets a weight coefficient of 1 to a green wavelength range of the leaf having the highest spectral reflectance, and sets a weight coefficient of 0 to the other wavelength ranges. Only a luminance signal in the green wavelength range is thus extracted and received by the AE detection unit 24. As illustrated in FIG. 5, the leaf has a signal peak in the green (G) wavelength range. Thus, the AE detection unit 24 detects a peak of the extracted signal, which allows the exposure control unit 29 to perform the AE control without being hindered by the luminance value of a signal of the soil, for example, having a peak in a wavelength range other than the green wavelength range. Controlling the peak value of the extracted green wavelength makes it possible to set correct luminance of the leaf.

Alternatively, the weight coefficient of each wavelength to be set to the weighted average unit 23 may not be a simple value such as 0 or 1 but may be a value set at the same ratio as the spectral characteristic of the desired object. This enables the exposure control unit 29 to perform the AE control focusing on a wavelength signal of a desired object with a high reflectance and set correct luminance of the leave.

### 1.3 Modification Example

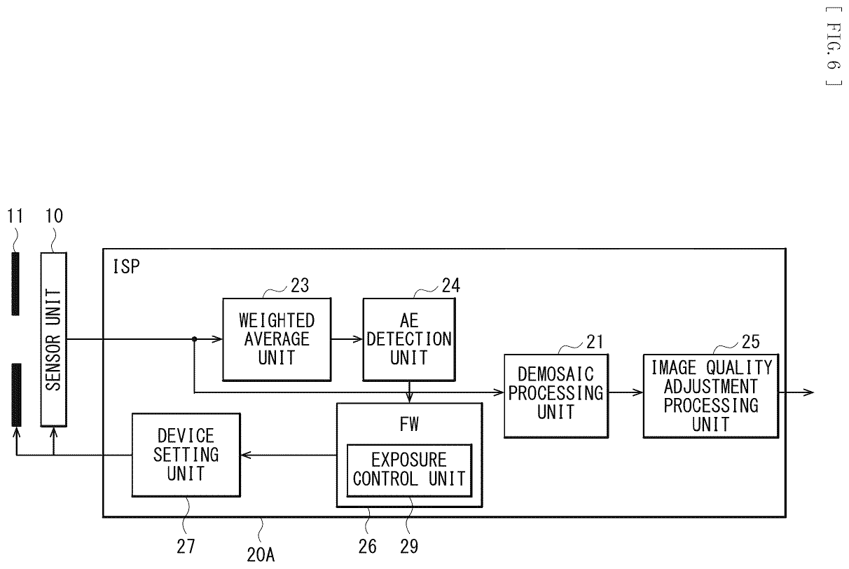

FIG. 6 schematically illustrates a configuration example of an imaging apparatus according to a modification example of the first embodiment.

In the configuration example illustrated in FIG. 1, the weighted average unit 23 receives the wavelength signals after the linear matrix processing. Accordingly, the processing necessary for the AE control is performed on the basis of separate wavelength signals in narrow wavelength ranges. This makes it possible to detect only the wavelength signal of the desired object with higher accuracy than in a case where no linear matrix processing is performed.

In contrast, as in the modification example illustrated in FIG. 6, the linear matrix processing may be omitted, and the weighted average unit 23 may receive multiple wavelength signals from the sensor unit 10. In the modification example illustrated in FIG. 6, an ISP 20A is provided in which the linear matrix processing unit 22 in the configuration example illustrated in FIG. 1 is omitted. This eliminates the need for the linear matrix processing, reducing an operational amount necessary for the AE control. In the modification example illustrated in FIG. 6, the image quality adjustment processing unit 25 conducts a variety of image quality adjustment processing on the multiple wavelength signals after the demosaic processing is performed by the demosaic processing unit 21, and outputs the resultant signals as a captured image.

### 1.4 Effect

According to the imaging apparatus of the first embodiment described above, the exposure control is performed on the basis of the detection value in accordance with the spectral characteristic of the desired object. Accordingly, it is possible to achieve correct exposure.

Further, according to the imaging apparatus according to the first embodiment, it is possible to achieve high accuracy AE control following the luminance in an imaging environment. In addition, in a use case in which imaging of multiple objects having multiple different spectral reflection characteristics is performed, it is possible to achieve the AE control that enables a desired object to be correctly exposed. For example, even in a case where imaging of multiple objects having a large luminance difference is performed, it is possible to achieve the AE control that enables a desired object to be correctly exposed.

It is to be noted that the effects described herein are mere examples and non-limiting, and other effects may be provided. The same applies to effects of the other embodiments described below.

### 2. Second Embodiment

Next, an imaging apparatus according to a second embodiment of the present disclosure is described. It is to be noted that, in the following description, components substantially the same as those of the imaging apparatus according to the first embodiment are denoted by the same reference numerals and the descriptions thereof are omitted as appropriate.

### 2.1 Configuration

FIG. 7 schematically illustrates a configuration example of the imaging apparatus according to the second embodiment.

The imaging apparatus according to the second embodiment includes an ISP 20B. The ISP 20B includes a ratio determination unit 28 in place of the weighted average unit 23 in the configuration of the imaging apparatus according to the first embodiment illustrated in FIG. 1.

The ratio determination unit 28 is a ratio determination circuit that identifies multiple wavelength signals obtained from an imaging region corresponding to a desired object on the basis of the ratio between multiple wavelength signals calculated for each predetermined region of imaging by the multi-spectral sensor, and generates the identified wavelength signals as a detection signal.

The ratio determination unit 28 identifies the multiple wavelength signals obtained from the imaging region corresponding to the desired object using a determination frame set in a ratio space indicating the ratio between predetermined multiple wavelengths.

In a case where the ratio determination unit 28 fails to identify the multiple wavelength signals obtained from the imaging region corresponding to the desired object, the ratio determination unit 28 may generate an average signal of multiple wavelength signals obtained from all regions of imaging by the multi-spectral sensor as the detection signal (all pixel average photometry mode).

On the basis of the detection signal generated by the ratio determination unit 28, the AE detection unit 24 detects a luminance signal in accordance with the spectral characteristic of the desired object.

### 2.2 Operation

According to the imaging apparatus of the second embodiment, the signal ratio between wavelengths is evaluated for each imaging region including at least one pixel, and only a pixel value in the imaging region satisfying a predetermining condition regarding the signal ratio between wavelengths is detected to achieve correct exposure of the desired object.

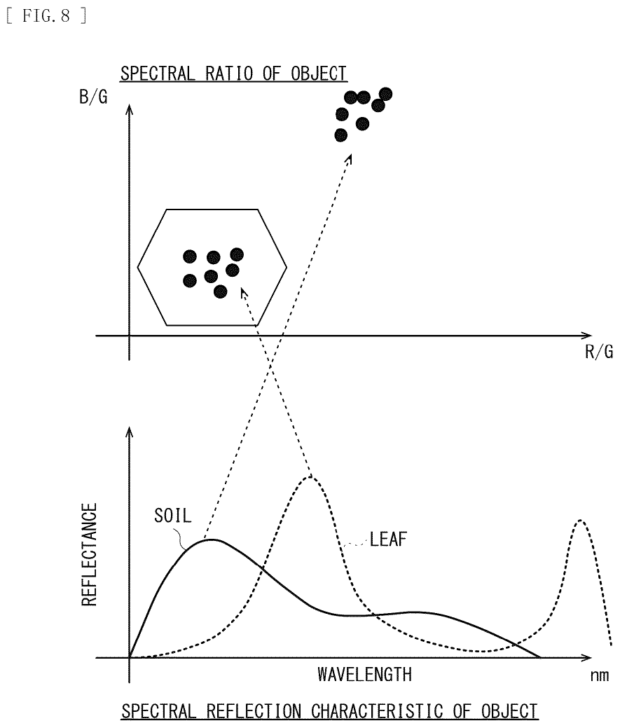

FIG. 8 illustrates exemplary spectral ratios of objects and exemplary spectral reflection characteristics of the objects. An upper part of FIG. 8 illustrates the spectral ratios of the objects in a ratio space indicating the ratio between multiple wavelengths of red (R), green (G), and blue (B). The ratio space illustrated in the upper part of FIG. 8 has a vertical axis representing G/B and a horizontal axis representing R/G. In the example illustrated in FIG. 8, in a case where imaging of the objects including a leaf and soil is performed as illustrated in FIG. 4, the wavelength of the leaf as a desired object is included within the determination frame.

The ratio determination unit 28 determines whether the signal ratio of each wavelength in an imaging region including at least one pixel matches the spectral ratio of the desired object. The AE detection unit 24 outputs only a detection value of the pixel value that satisfies the condition to the exposure control unit 29. Here, the determination frame is preliminarily designed on the basis of the spectral ratio of the desired object, for example. Accordingly, it is possible to achieve the AE control dedicated to the desired object in a use case in which imaging of multiple objects having different spectral reflection characteristics is performed, for example.

The ratio determination unit 28 evaluates the wavelength signal ratio of each wavelength, and outputs only the wavelength signal of the imaging region that matches the range of the determination frame set in the ratio space as the detection signal to the AE detection unit 24. The ratio determination unit 28 thus determines whether or not any of the multiple wavelength signal ratios corresponds to the spectral ratio of the desired object. Accordingly, higher wavelength separation performance is obtainable as compared with the all pixel average photometry mode, for example.

Further, in a case where a pixel satisfying the condition is not present, the ratio determination unit 28 may switch to the all pixel average photometry mode, and switches to the detection method using the determination frame after correct brightness is achieved by the average photometry in the entire screen. Accordingly, in a case where overexposure or black defects are caused by a rapid change in environmental luminance, the entire screen is correctly exposed by the average photometry before switching to the detection method using the determination frame. This enhances stability.

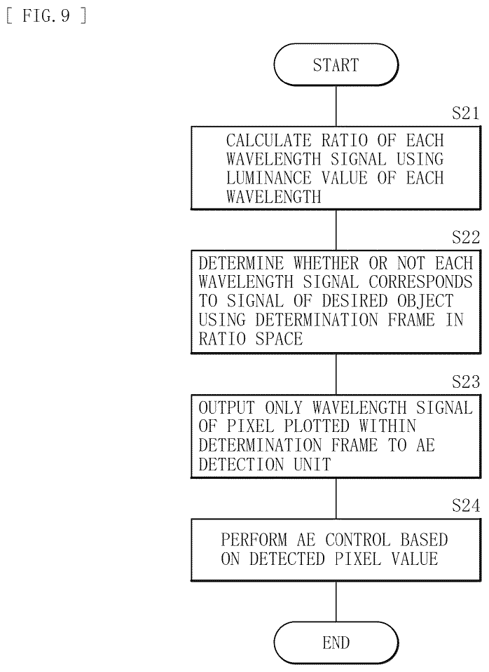

FIG. 9 is a flowchart illustrating an exemplary processing operation flow of the exposure control by the imaging apparatus according to the second embodiment.

First, the ratio determination unit 28 calculates the ratio of each wavelength signal using the luminance value of each wavelength (Step S21). Thereafter, the ratio determination unit 28 determines whether or not any of the wavelength signals corresponds to a signal of the desired object using the determination frame in the ratio space (Step S22). Thereafter, the ratio determination unit 28 outputs only the wavelength signal of the pixel plotted within the determination frame to the AE detection unit 24 (Step S23). Thereafter, the exposure control unit 29 performs the AE control on the basis of the detected pixel value (Step S24).

### (Design of Determination Frame)

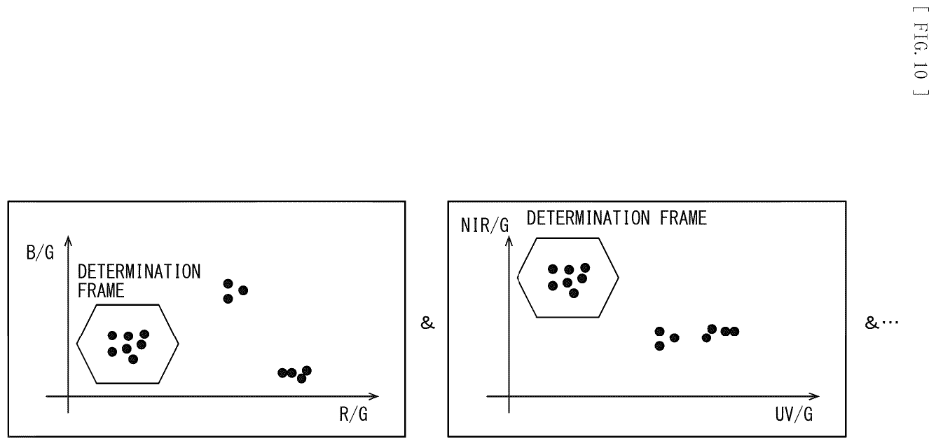

FIG. 10 illustrates multiple exemplary ratio spaces. In the example in FIG. 10, a B/G vs RG ratio space and an NIR/G vs UV/G ratio space are illustrated as the multiple ratio spaces.

(1) The determination frame of the ratio determination unit 28 may be any determination frame set by the user in high-dimensional ratio spaces using all wavelength signals after the linear matrix processing with respect to a reference wavelength. Examples of the high-dimensional ratio spaces may include B/G vs R/G, R/G vs NIR/G, NIR/G vs NIR/G, NIR/G vs UV/G, UV/G vs Y/G, Y/G vs Cy/G. This saves the user from having to select a wavelength to be used for the determination, achieving the determination of a desired object with higher accuracy than in a method (2) described below. The determination may be made at a lower cost than in a method (3) described below.

(2) The determination frame of the ratio determination unit 28 may be any determination frame set by the user in a ratio space where the user is able to select any wavelength range to be used in the determination and extract the luminance of a desired object. This enables the determination of a desired object to be made in a specific ratio space (e.g., only in B/G vs R/G or R/G vs NIR/G), for example, reducing an operation amount as compared with the method (1) described above. Further, the determination may be made at a lower cost than in the method (3) described below.

(3) As in a fourth embodiment to be described later (FIG. 15), the user may select any wavelength range to be used for the determination, and the determination frame of the ratio determination unit 28 may be dynamically set on the basis of a captured image captured by the sensor unit 10. This saves the user from having to set the determination frame and allows the determination frame to be easily set through a simple operation depending on a use case, as compared with the methods (1) and (2) described above.

### 2.3 Modification Example

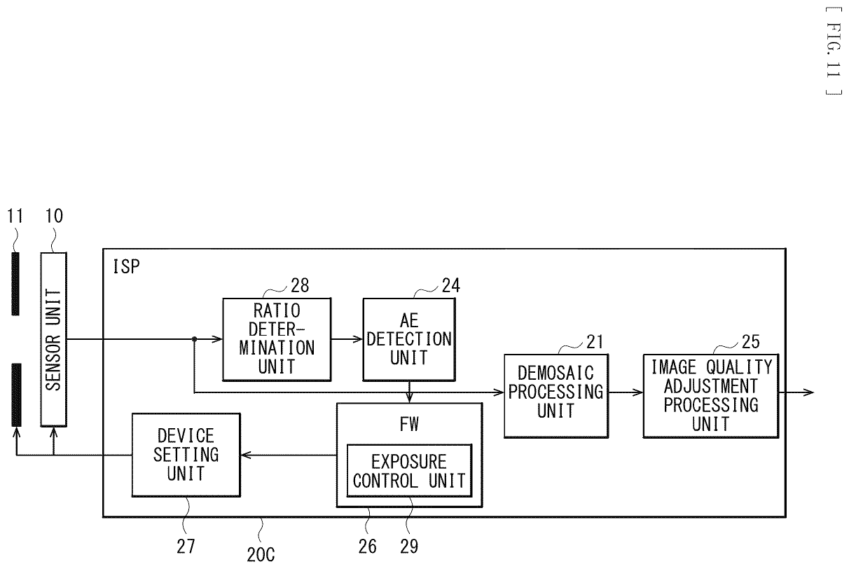

FIG. 11 schematically illustrates a configuration example of an imaging apparatus according to a modification example of the second embodiment.

In the configuration example illustrated in FIG. 7, the ratio determination unit 28 receives the wavelength signals after the linear matrix processing. Accordingly, the processing necessary for the AE control is performed on the basis of separate wavelength signals in narrow wavelength ranges. This makes it possible to detect only the wavelength signal of the desired object with higher accuracy than in a case where no linear matrix processing is performed.

In contrast, as in the modification example illustrated in FIG. 11, the linear matrix processing may be omitted, and the ratio determination unit 28 may receive multiple wavelength signals from the sensor unit 10. In the modification example illustrated in FIG. 11, an ISP 20C is provided in which the linear matrix processing unit 22 in the configuration example illustrated in FIG. 7 is omitted. This eliminates the need for the linear matrix processing, reducing an operation amount necessary for the AE control. In the modification example illustrated in FIG. 11, the image quality adjustment processing unit 25 conducts a variety of image quality adjustment processing on the multiple wavelength signals after the demosaic processing is performed by the demosaic processing unit 21, and outputs the resultant signals as a captured image.

### 2.4 Effect

According to the imaging apparatus of the second embodiment described above, the exposure control is performed on the basis of the detection value in accordance with the spectral ratio of the desired object. Accordingly, it is possible to achieve correct exposure.

The other configurations, operations, and effects may be substantially similar to those of the imaging apparatus according to the first embodiment described above.

### 3. Third Embodiment

Next, an imaging apparatus according to a third embodiment of the present disclosure is described. It is to be noted that, in the following description, components substantially the same as those of the imaging apparatus according to the first embodiment or the second embodiment are denoted by the same reference numerals and the descriptions thereof are omitted as appropriate.

### 3.1 Configuration

FIG. 12 schematically illustrates a configuration example of the imaging apparatus according to the third embodiment.

The imaging apparatus according to the third embodiment further includes an application processor (AP) 30 and a graphical user interface (GUI) 40 as compared with the configuration of the imaging apparatus according to the first embodiment.

The AP 30 includes an object detection unit 31, a region designation unit 32, a wavelength weight determination unit 33, and a weight control unit 34.

The GUI 40 includes an object designation GUI 41, a region designation GUI 42, and a wavelength weight designation GUI 43.

The object detection unit 31 is an object detection circuit that detects an image of a desired object in an image captured by the multi-spectral sensor. The object detection unit 31 receives the captured image from the image quality adjustment processing unit 25. The desired object detected by the object detection unit 31 may be designated by the object designation GUI 41. In addition, the object designation GUI 41 is a wavelength designation unit that designates a wavelength to be used to detect the image of the desired object by the object detection unit 31.

The object detection unit 31 designates an imaging region in which the image of the object is to be detected on the basis of the designation by the region designation GUI 42.

The wavelength weight determination unit 33 is a weight determination circuit that determines the setting value of a weight coefficient on the basis of the image of the desired object detected by the object detection unit 31. The setting value of the weight coefficient may be set by the wavelength weight designation GUI 43. The wavelength weight designation GUI 43 is a weight designation unit that designates the setting value of a weight coefficient.

The weight control unit 34 controls the setting value of a weight coefficient of the weighted average unit 23.

### 3.2 Operation

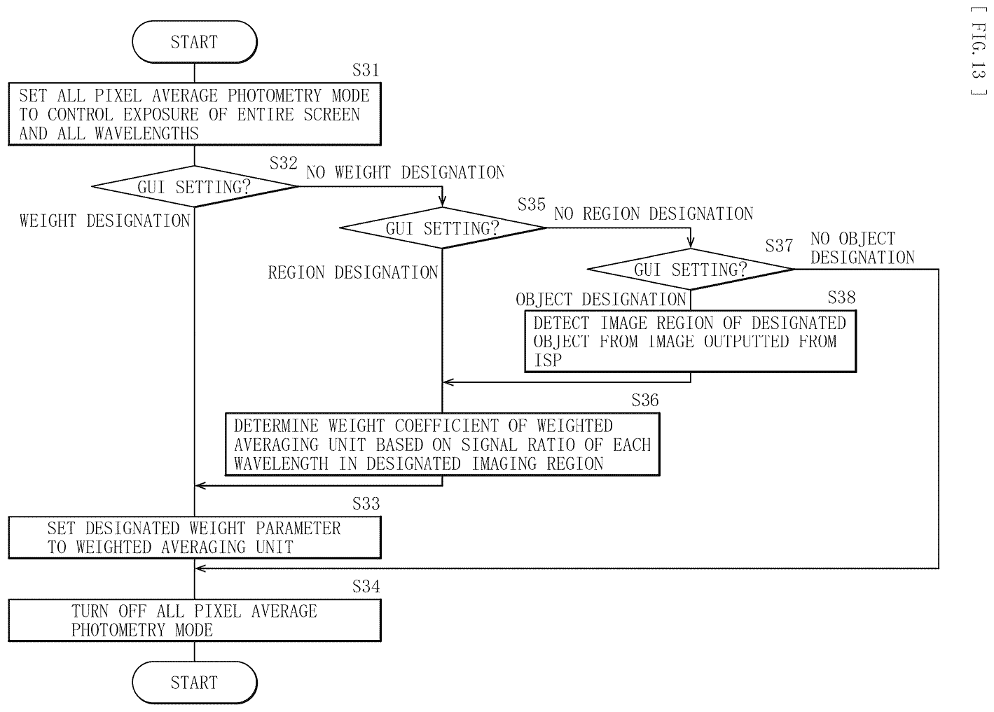

FIG. 13 illustrates an exemplary processing operation flow of the exposure control by the imaging apparatus according to the third embodiment.

First, the exposure control unit 29 sets the all pixel average photometry mode to control the exposure of the entire screen and all of the wavelengths (Step S31). Thereafter, the weight control unit 34 determines whether a GUI setting has been made by the wavelength weight designation GUI 43 (Step 32). If it is determined that weight designation has been made, the weight control unit 34 then sets a designated weight parameter to the weighted average unit 23 (Step S33). Thereafter, the exposure control unit 29 turns off the all pixel average photometry mode (Step S34) and ends the processing.

In contrast, if it is determined that no weight designation has been made, the weight control unit 34 then determines whether a GUI setting has been made by the region designation GUI 42 (Step S35). If it is determined that the region designation has been made, the weight control unit 34 then determines a weight coefficient of the weighted average unit 23 on the basis of the signal ratio of each wavelength in the designated imaging region (Step S36), and causes the processing to proceed to Step S33.

In contrast, if it is determined that no region designation has been made, the weight control unit 34 then determines whether a GUI setting has been made by the object designation GUI 41 (Step S37). If it is determined that the object designation has been made, the object detection unit 31 then detects the imaging region of the designated object from the image outputted from the ISP 20A (Step S38), and causes the processing to proceed to Step S36. In contrast, if it is determined that no object designation has been made, the exposure control unit 29 then causes the processing to proceed to Step S34.

### (Processing at Object Detection Unit 31)

Multiple wavelength signals outputted from the multi-spectral sensor may include a red signal, a green signal, and a blue signal. In this case, the object detection unit 31 may detect an image of a desired object by setting an RGB image including a red signal, a green signal, and a blue signal as a captured image. In this case, training data for the object detection is generally an RGB image, and thus special learning in the object detection unit 31 is not necessary.

Alternatively, the object detection unit 31 may detect an image of a desired object with setting a luminance image in which the red signal, the green signal, and the blue signal are converted into respective luminance signals as the captured image. In this case, training data for the object detection is a luminance image in many cases, and thus special learning in the object detection unit 31 is not necessary.

Further, the wavelength range of the captured image received by the object detection unit 31 may be designated by the user through the object designation GUI 41. This allows the user to set a desired object detection depending on an application, for example, making it easy to detect an object in an NIR image.

### (Processing at Wavelength Weight Determination Unit 33)

(1) The wavelength weight determination unit 33 may determine the value of the weight coefficient corresponding to the image of the desired object detected by the object detection unit 31 on the basis of weight relating data in which multiple pieces of object data and the values of the weight coefficients corresponding to the respective pieces of object data are associated with each other. In this case, the object data and the weight coefficients are prepared in association with each other in the wavelength weight determination unit 33. This reduces an operation amount as compared with a method (2) described below.

2) The wavelength weight determination unit 33 may evaluate the luminance of each of the multiple wavelengths in the image of the desired object detected by the object detection unit 31, and may determine the setting value of a weight coefficient corresponding to the image of the desired object detected by the object detection unit 31 on the basis of the result of the evaluation. In this case, the setting value of the weight coefficient is dynamically determined on the basis of the luminance of each wavelength in the environment. This achieves setting of the weight coefficient depending on the use case.

### 3.3 Modification Example

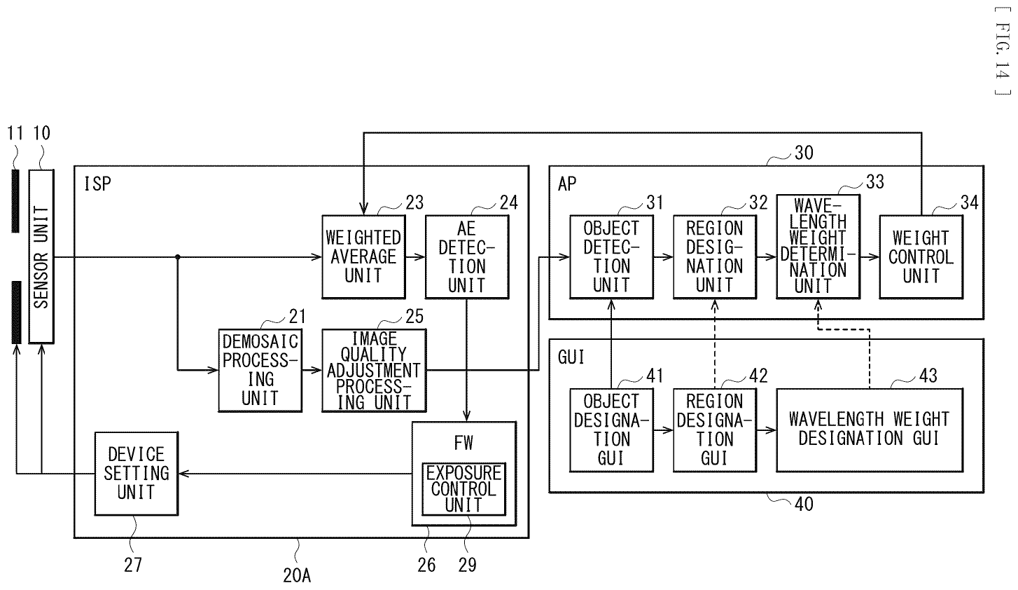

FIG. 14 schematically illustrates a configuration example of an imaging apparatus according to a modification example of the third embodiment.

In the configuration example illustrated in FIG. 12, the weighted average unit 23 receives the wavelength signals after the linear matrix processing. Accordingly, it is the processing necessary for the AE control is performed on the basis of separate wavelength signals in narrow wavelength ranges. This makes it possible to detect only the wavelength signal of the desired object with higher accuracy than in a case where no linear matrix processing is performed.

In contrast, as in the modification example illustrated in FIG. 14, the linear matrix processing may be omitted, and the weighted average unit 23 may receive multiple wavelength signals from the sensor unit 10. In the modification example illustrated in FIG. 14, the ISP 20A is provided in which the linear matrix processing unit 22 in the configuration example illustrated in FIG. 12 is omitted. This eliminates the need for the linear matrix processing, reducing an operation amount necessary for the AE control. In the modification example illustrated in FIG. 14, the image quality adjustment processing unit 25 conducts a variety of image quality adjustment processing on the multiple wavelength signals after the demosaic processing is performed by the demosaic processing unit 21, and outputs the resultant signals as a captured image.

### 3.4 Effect

According to the imaging apparatus of the third embodiment described above, the setting of the wavelength coefficient for each wavelength in the weighted average unit 23 is dynamically determined on the basis of a captured image. This achieves calibration of the setting value of a weight coefficient in each imaging environment and thus allows the user to easily tune the weight coefficient.

The other configurations, operations, and effects may be substantially similar to those of the imaging apparatus according to the first embodiment described above.

### 4. Fourth Embodiment

Next, an imaging apparatus according to a fourth embodiment of the present disclosure is described. It is to be noted that, in the following description, components substantially the same as those of the imaging apparatus according to any of the first to third embodiments described above are denoted by the same reference numerals and the descriptions thereof are omitted as appropriate.

### 4.1 Configuration

FIG. 15 schematically illustrates a configuration example of the imaging apparatus according to the fourth embodiment.

The imaging apparatus according to the fourth embodiment further includes an AP 30A and a GUI 40A as compared with the configuration of the imaging apparatus according to the second embodiment (FIG. 7).

The AP 30A includes the object detection unit 31, the region designation unit 32, a determination frame determination unit 33A, and a determination frame control unit 34A.

The GUI 40A includes the object designation GUI 41, the region designation GUI 42, and a determination frame designation GUI 43A.

The object detection unit 31 is an object detection circuit that detects an image of a desired object in an image captured by the multi-spectral sensor. The object detection unit 31 receives the captured image from the image quality adjustment processing unit 25. The desired object detected by the object detection unit 31 may be designated by the object designation GUI 41. In addition, the object designation GUI 41 is a wavelength designation unit that designates a wavelength to be used to detect the image of the desired object by the object detection unit 31.

The object detection unit 31 designates an imaging region in which the image of the object is to be detected on the basis of the designation by the region designation GUI 42.

The determination frame determination unit 33A determines a setting value of the determination frame on the basis of the image of the desired object detected by the object detection unit 31. The setting value of the determination frame may be designated by the determination frame designation GUI 43A. The determination frame designation GUI 43A is a determination frame designation unit that designates the setting value of the determination frame to be used in the determination frame determination unit 33A.

The determination frame control unit 34A controls the setting value of the determination frame to be used in the ratio determination unit 28.

### 4.2 Operation

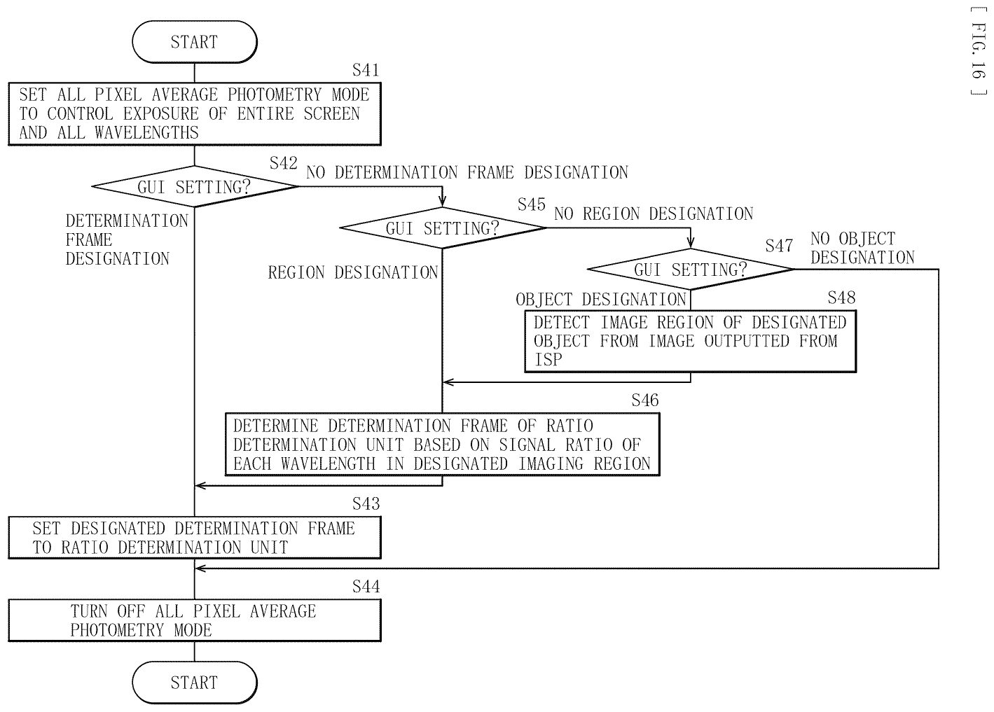

FIG. 16 illustrates an exemplary processing operation flow of the exposure control by the imaging apparatus according to the fourth embodiment.

First, the exposure control unit 29 sets the all pixel average photometry mode to control the exposure of the entire screen and all of the wavelengths (Step S41). Thereafter, the determination frame control unit 34A determines whether a GUI setting is set by the determination frame designation GUI 43A (Step S42). If it is determined that determination frame designation has been made, the determination frame control unit 34A then sets the designated determination frame to the ratio determination unit 28 (Step S43). Thereafter, the exposure control unit 29 turns off the all pixel average photometry mode (Step S44) and ends the processing.

In contrast, if it is determined that no determination frame designation has been made, the determination frame control unit 34A then determines whether a GUI setting has been made by the region designation GUI 42 (Step S45). If it is determined that the region designation has been made, the determination frame control unit 34A then determines the determination frame of the ratio determination unit 28 on the basis of the signal ratio of each wavelength in the designated imaging region (Step S46), and causes the processing to proceeds to Step S43.

In contrast, if it is determined that no region designation has been made, the determination frame control unit 34A then determines whether a GUI setting has been made by the object designation GUI 41 (Step S47). If it is determined that the object designation has been made, the object detection unit 31 then detects the imaging region of the designated object from the image outputted from the ISP 20B (Step S48), and causes the processing to proceeds to Step S46. In contrast, if it is determined that no object designation has been made, the exposure control unit 29 then causes the processing to proceed to Step S44.

### (Processing at Determination Frame Determination Unit 33A)

(1) The determination frame determination unit 33A may determine the setting value of the determination frame corresponding to the image of the desired object detected by the object detection unit 31 on the basis of determination frame relating data in which multiple pieces of object data and the setting values of the determination frames corresponding to the respective objects are associated with each other. In this case, the object data and the setting values of the determination frames are prepared in association with each other in the determination frame determination unit 33A. This reduces an operation amount as compared with a method (2) described below.

(2) The determination frame determination unit 33A may evaluate the luminance of each of the multiple wavelengths in the image of the desired object detected by the object detection unit 31, and may determine the setting value of a determination frame corresponding to the image of the desired object detected by the object detection unit 31 on the basis of the result of the evaluation. In this case, the setting value of the determination frame is dynamically determined on the basis of the luminance of each wavelength in the environment. This achieves setting of the determination frame depending on the use case.

### 4.3 Modification Example

### Modification Example 1

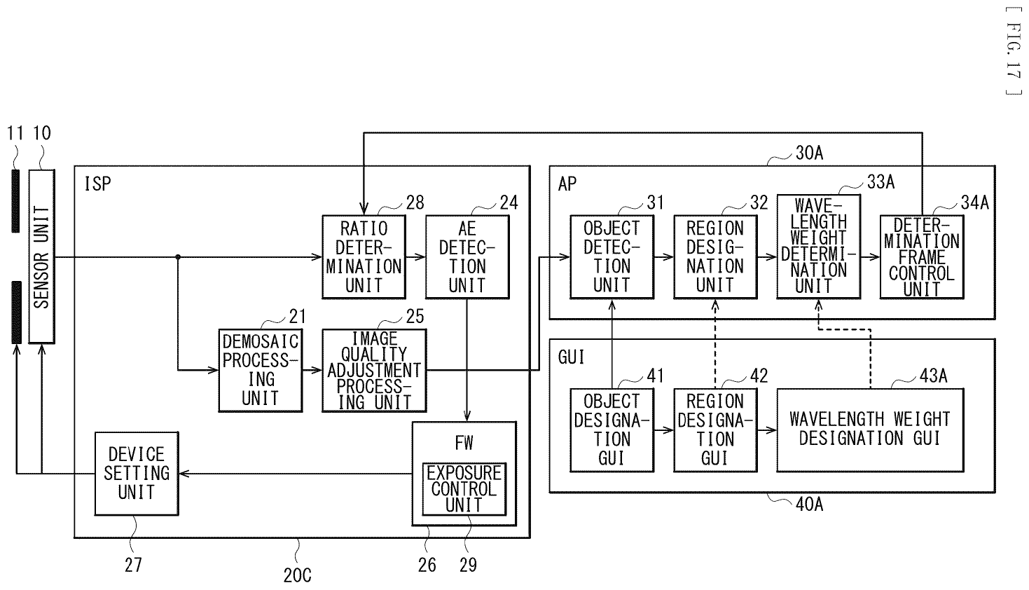

FIG. 17 schematically illustrates a configuration example of an imaging apparatus according to Modification Example 1 of the fourth embodiment.

In the configuration example illustrated in FIG. 15, the ratio determination unit 28 receives the wavelength signals after the linear matrix processing. Accordingly, the processing necessary for the AE control is performed on the basis of separate wavelength signals in narrow wavelength ranges. This makes it possible to detect only the wavelength signal of the desired object with higher accuracy than in a case where no linear matrix processing is performed.

In contrast, as in Modification Example 1 illustrated in FIG. 17, the linear matrix processing may be omitted, and the ratio determination unit 28 may receive multiple wavelength signals from the sensor unit 10. In Modification Example 1 illustrated in FIG. 17, the ISP 20C is provided in which the linear matrix processing unit 22 in the configuration example illustrated in FIG. 15 is omitted. This eliminates the need for the linear matrix processing, reducing an operation amount necessary for the AE control. In Modification Example 1 illustrated in FIG. 17, the image quality adjustment processing unit 25 conducts a variety of image quality adjustment processing on the multiple wavelength signals after the demosaic processing is performed by the demosaic processing unit 21, and outputs the resultant signals as a captured image.

### Modification Example 2

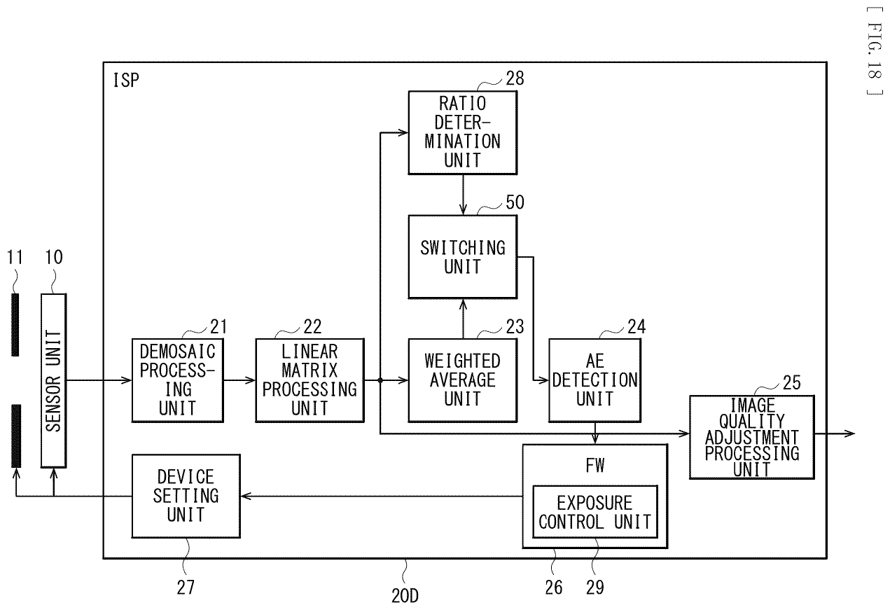

FIG. 18 schematically illustrates a configuration example of an imaging apparatus according to Modification Example 2 of the fourth embodiment.

In each of the embodiments described above, the configuration example in which either one of the weighted average unit 23 and the ratio determination unit 28 is provided is described. However, a configuration including both of the weighted average unit 23 and the ratio determination unit 28 may be employed.

For example, as illustrated in FIG. 18, a configuration in which an ISP 20D including the weighted average unit 23, the ratio determination unit 28, and a switching unit 50 is provided may be employed.

In the imaging apparatus according to Modification Example 2, the AE detection unit 24 detects the luminance signal in accordance with the spectral characteristic of a desired object on the basis of the weighted average signal generated by the weighted average unit 23 or the detection signal generated by the ratio determination unit 28. The switching unit 50 switches the signal to be received by the AE detection unit 24 between the weighted average signal generated by the weighted average unit 23 and the detection signal generated by the ratio determination unit 28.

### (Switching by Switching Unit 50)

(1) The switching unit 50 may make a switch in accordance with manual designation by the user. This reduces an operation amount as compared with a method (2) described below.

(2) The switching unit 50 may automatically make a switch on the basis of a predetermined trigger to be described later. This achieves switching more suitable for a use case than the method (1) described above.

Here, using the weighted average unit 23 for the AE detection saves electric consumption as compared with the case where the ratio determination unit 28 is used. However, although signals of objects other than the desired object are detected in a case where the weighted average unit 23 is used, whereas the imaging region is divided and thus separation performance is enhanced in a case where the ratio determination unit 28 is used.

The trigger for switching by the switching unit 50 may be as follows, for example. For example, in a power saving mode, switching may be made to a setting in which the weighted average unit 23 is used. Further, in a separation performance priority mode, switching may be made to a setting in which the ratio determination unit 28 is used. In addition, in a case where a desired object is detected by the object detection unit 31, switching may be made to a setting in which the ratio determination unit 28 is used. Further, if no pixel is plotted within the determination frame when the ratio determination unit 28 is used, switching may be made to a setting in which the weighted average unit 23 is used.

### 4.4 Effect

According to the imaging apparatus of the fourth embodiment described above, the setting of the determination frame of the ratio determination unit 28 is dynamically determined on the basis of a captured image. This achieves calibration of the setting value of the determination frame in each imaging environment and allows the user to easily tune the determination frame.

The other configurations, operations, and effects may be substantially similar to those of the imaging apparatus according to any of the first to third embodiments described above.

### 5. Fifth Embodiment

Next, an imaging apparatus according to a fifth embodiment of the present disclosure is described. It is to be noted that, in the following description, components substantially the same as those of the imaging apparatus according to any of the first to fourth embodiments described above are denoted by the same reference numerals and the descriptions thereof are omitted as appropriate.

### 5.1 Configuration

FIG. 19 schematically illustrates a configuration example of the imaging apparatus according to the fifth embodiment.

The imaging apparatus according to the fifth embodiment includes an ISP 20E in place of the ISP 20 in the configuration of the imaging apparatus according to the third embodiment (FIG. 12). Although the ISP 20 includes a single AE detection unit 24, the ISP 20E includes multiple AE detection units 241, 242, to 24N. Further, the imaging apparatus according to the fifth embodiment includes a GUI 40B in place of the GUI 40 in the configuration of the imaging apparatus according to the third embodiment (FIG. 12). The GUI 40B includes the object designation GUI 41, the region designation GUI 42, the wavelength weight designation GUI 43, and a blend ratio designation GUI 44.

The multiple AE detection units 241, 242 to 24N detect multiple luminance signals in accordance with respective spectral characteristics of multiple desired objects on the basis of multiple different detection signals generated using the multiple wavelength signals outputted from the multi-spectral sensor. It is to be noted that the multiple different detection signals may be received by the multiple AE detection units 241, 242 to 24N by changing the setting value of the weight coefficient to be used in the weighted average unit 23.

On the basis of the multiple detection values received by the multiple AE detection units 241, 242 to 24N, the exposure control unit 29 performs the exposure control in accordance with the spectral characteristics of the multiple desired objects.

Further, the exposure control unit 29 performs the exposure control in accordance with the spectral characteristics of the multiple desired objects on the basis of the result of mixing (blending) the multiple detection values. Alternatively, the exposure control unit 29 may perform the exposure control on the basis of any one of the multiple detection values.

The blend ratio designation GUI 44 is a mixing ratio designation unit that designates a mixing ratio (blend ratio) among the multiple detection values.

The wavelength weight designation GUI 43 includes a GUI configured to designate multiple objects, regions, or wavelengths.

### 5.2 Operation

In the imaging apparatus according to the fifth embodiment, the multiple AE detection units 241, 242 to 24N each calculate a detection value for each wavelength designated by the GUI 40B. The exposure control unit 29 blends these detection values to perform the AE control dedicated to the luminance of the objects having multiple wavelengths. The setting value of the weight coefficient to be used in the weighted average unit 23 is determined in accordance with the spectral characteristics of the multiple objects.

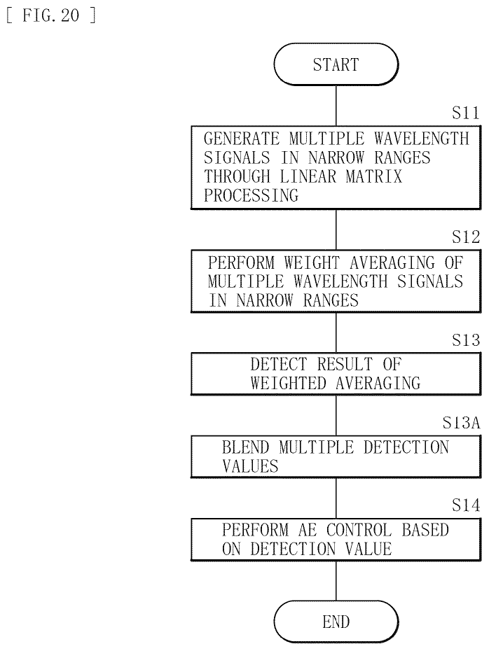

FIG. 20 is a flowchart illustrating an exemplary overall processing operation flow of the exposure control by the imaging apparatus according to the fifth embodiment.

First, the linear matrix processing unit 22 generates multiple wavelength signals in narrow ranges through linear matrix processing (Step S11). Thereafter, the weighted average unit 23 performs weighted averaging of the multiple wavelength signals in the narrow ranges (Step S12). Thereafter, the multiple AE detection units 241, 242 to 24N each detect the result of the weighted averaging (Step S13).

Thereafter, the exposure control unit 29 blends the multiple detection values detected by the multiple AE detection units 241, 242 to 24N (Step S13A). Thereafter, the exposure control unit 29 performs the AE control on the basis of the detection value after the blending (Step S14).

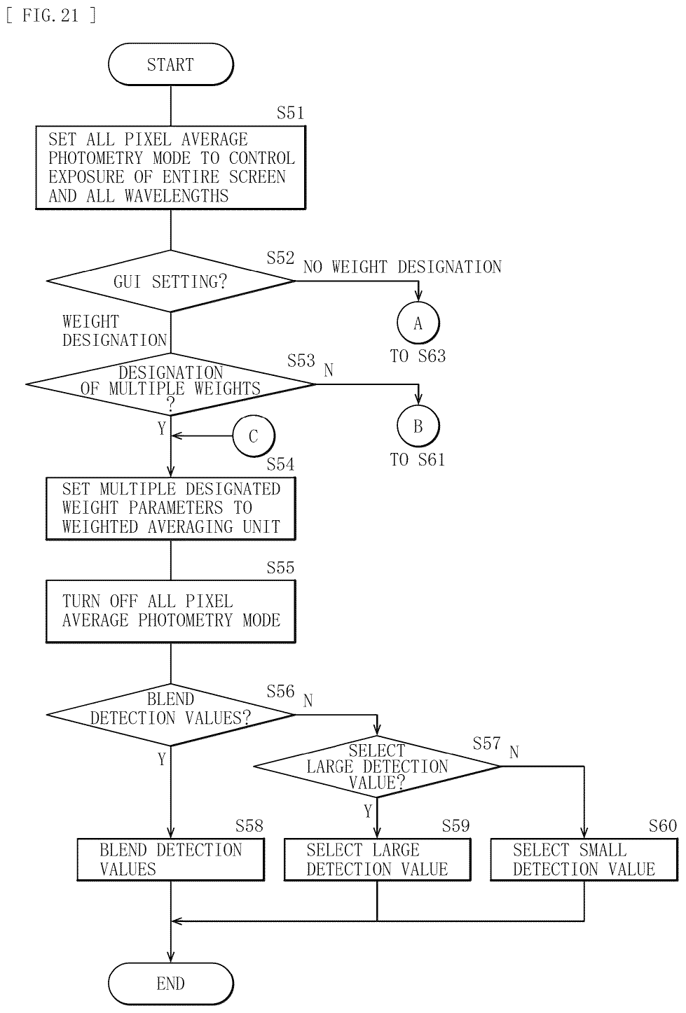

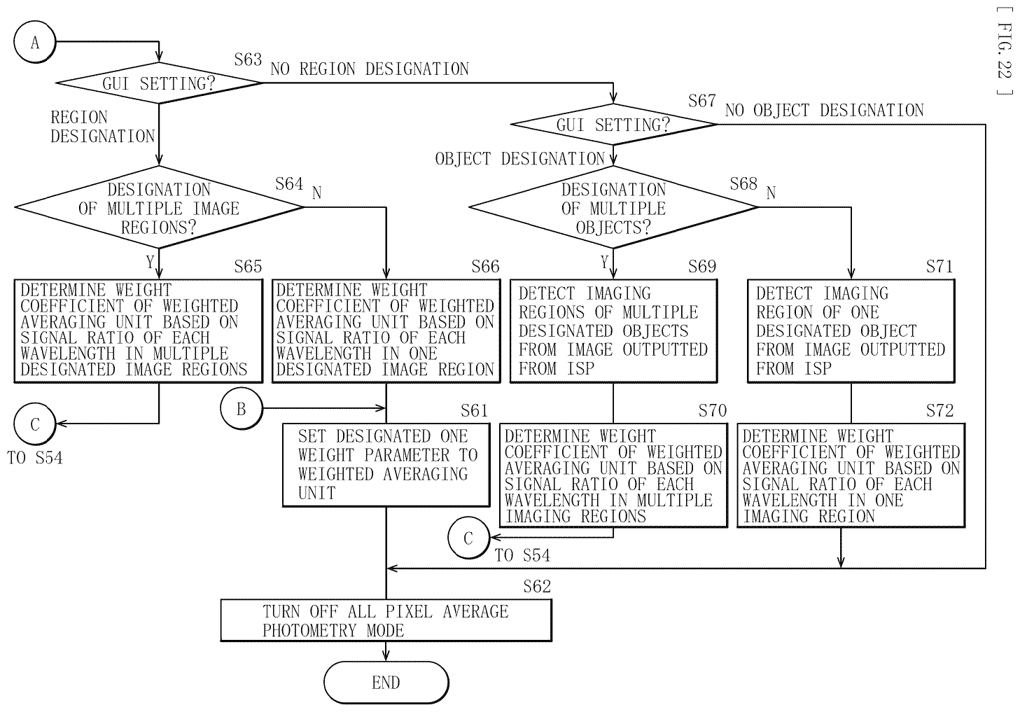

FIG. 21 is a flowchart illustrating an exemplary processing operation flow of the exposure control by the imaging apparatus according to the fifth embodiment. FIG. 22 is a flowchart subsequent to FIG. 21.

First, the exposure control unit 29 sets the all pixel average photometry mode to control the exposure of the entire screen and all of the wavelengths (Step S51). Thereafter, the weight control unit 34 determines whether a GUI setting has been made by the wavelength weight designation GUI 43 (Step S52). If it is determined that weight designation has been made, the weight control unit 34 then determines whether designation of multiple weights has been made (Step S53). If it is determined that designation of multiple weights has been made (Step S53: Y), the weight control unit 34 then sets the multiple designated weight parameters to the weighted average unit 23 (Step S54). Thereafter, the exposure control unit 29 turns off the all pixel average photometry mode (Step S55).

Thereafter, the exposure control unit 29 determines whether to blend the multiple detection values (Step S56). If it is determined that the multiple detection values are to be blended (Step S56: Y), the exposure control unit 29 blends the multiple detection values (Step S57), and ends the processing. In contrast, if it is determined that the detection values are not to be blended (Step S56: N), the exposure control unit 29 then determines whether to select a large detection value (Step S58). If it is determined that a large detection value is to be selected (Step S58: Y), the exposure control unit 29 selects the large detection value (Step S59), and ends the processing. In contrast, if it is determined that a large detection value is not to be selected (Step S58: N), the exposure control unit 29 selects a small detection value (Step S60), and ends the processing.

If it is determined in the process at Step S52 that no weight designation has been made, the weight control unit 34 then determine whether a GUI setting has been made by the region designation GUI 42 (Step S63). If it is determined that the region designation has been made, the weight control unit 34 then determines whether designation of multiple regions has been made (Step S64). If it is determined that designation of multiple regions has been made (Step S64: Y), the wavelength weight determination unit 33 then determines a weight coefficient of the weighted average unit 23 on the basis of the signal ratio of each wavelength in the multiple designated imaging regions (Step S65), and causes the processing to proceed to Step S54. In contrast, it is determined that designation of multiple regions has not been made (Step S64: N), the wavelength weight determination unit 33 then determines a weight coefficient of the weighted average unit 23 on the basis of the signal ratio of each wavelength in the one designated region (Step S66). Thereafter, the weight control unit 34 sets the one designated weight parameter to the weighted average unit 23 (Step S61). Thereafter, the exposure control unit 29 turns off the all pixel average photometry mode (Step S62) and ends the processing.

If it is determined in the process at Step S63 that region designation has not been made, the weight control unit 34 then determines whether a GUI setting has been made by the object designation GUI 41 (Step S67). If it is determined that no object designation has been made, the weight control unit 34 then causes the processing to proceed to Step S62. In contrast, if it is determined that object designation has been made, the weight control unit 34 then determines whether designation of multiple objects has been made (Step S68). If it is determined that designation of multiple objects has been made (Step S68: Y), the object detection unit 31 then detects the imaging region of each of the multiple designated objects from the image outputted from the ISP 20E (Step S69). Thereafter, the wavelength weight determination unit 33 determines a weight coefficient of the weighted average unit 23 on the basis of the signal ratio of each wavelength in the multiple designated imaging regions (Step S70) and causes the processing to proceed to Step S54.

In contrast, if it is determined that designation of multiple objects has not been made (Step S68: N), the object detection unit 31 then detects the imaging region of the one designated object from the image outputted from the ISP 20E (Step S71). Thereafter, the wavelength weight determination unit 33 determines a weight coefficient of the weighted average unit 23 on the basis of the signal ratio of each wavelength in the single designated imaging region (Step S72) and cause the processing to proceed to Step S62.

### (Method of Controlling Blend Ratio)

The exposure control unit 29 blends the multiple detection values in a ratio designated by the user using the blend ratio designation GUI 44.

Alternatively, the blend ratio may be automatically calculated. In this case, the blend ratio takes a larger value as the luminance value increases, for example. In addition, the blend ratio takes a larger value as the wavelength is closer to a wavelength desired by the user. Alternatively, the blend ratio may take a value depending on area.

Alternatively, the exposure control unit 29 may select any of the multiple detection values. In this case, the largest one (or the smallest one) of the detection values may be employed depending on the imaging environment, for example. For instance, the largest detection value may be employed in the daytime, and the smallest detection value may be employed in the night.

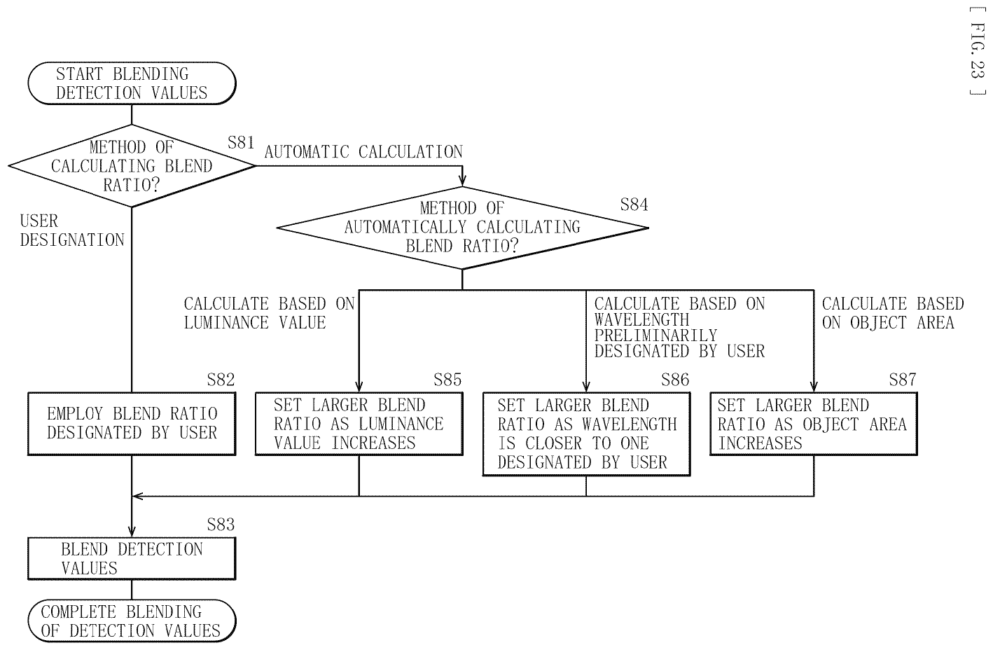

FIG. 23 is a flowchart illustrating an exemplary operation flow of a process of blending the detection values by the imaging apparatus according to the fifth embodiment.

First, the exposure control unit 29 determines a method of calculating the blend ratio (Step S81). If it is determined that the method of calculating the blend ratio is designation by the user using the blend ratio designation GUI 44, the exposure control unit 29 employs the blend ratio designated by the user (Step S82). Thereafter, the exposure control unit 29 blends the detection values (Step S83) and ends the processing.

In contrast, if it is determined that the method of calculating the blend ratio is an automatic calculation, the exposure control unit 29 then determines the method of automatically calculating the blend ratio (Step S84). If it is determined that the method of automatically calculating the blend ratio is a calculating method based on the luminance value, the exposure control unit 29 then sets a larger blend ratio as the luminance value increases (Step S85), blends the detection values (Step S83), and ends the processing.

If it is determined that the method of automatically calculating the blend ratio is a calculation method based on a wavelength preliminarily designated by the user, the exposure control unit 29 then sets a larger blend ratio as the wavelength is closer to the wavelength designated by the user (Step S86), blends the detection values (Step S83), and ends the processing.

If it is determined that the method of automatically calculating the blend ratio is a calculation method based on object area, the exposure control unit 29 then sets a larger blend ratio as the object area increases (Step S86), blends the detection values (Step S83), and ends the processing.

### 5.3 Effect

According to the imaging apparatus of the fifth embodiment described above, the automatic exposure control is achieved in multiple wavelength ranges or a broad wavelength range in the use case in which imaging of multiple objects having different spectral reflection characteristics is performed, for example. Further, if at least one value indicating too high brightness (or too low brightness) is included in multiple AE detection values, for example, the brightness is lowered (or increased) using the other detection values to achieve convergence on correct exposure.

The other configurations, operations, and effects may be substantially similar to those of the imaging apparatus according to the first or third embodiment described above.

### 6. Sixth Embodiment

Next, an imaging apparatus according to a sixth embodiment of the present disclosure is described. It is to be noted that, in the following description, components substantially the same as those of the imaging apparatuses according to any of the first to fifth embodiments are denoted by the same reference numerals and the descriptions thereof are omitted as appropriate.

### 6.1 Configuration

The imaging apparatus according to the sixth embodiment may have a configuration substantially similar to the configuration of the imaging apparatus according to the first embodiment (FIG. 1) and the configuration of the imaging apparatus according to the third embodiment (FIG. 12).

In the imaging apparatus according to the sixth embodiment, the multi-spectral sensor of the sensor unit 10 may perform imaging of multiple desired objects in a time division manner.

The AE detection unit 24 may detect multiple luminance signals in accordance with the spectral characteristics of the multiple desired objects on the basis of the multiple different detection signals generated in a time division manner using the multiple wavelength signals outputted from the multi-spectral sensor.

On the basis of the multiple detection values detected by the AE detection unit 24, the exposure control unit 29 may perform the exposure control in a time division manner in accordance with the spectral characteristics of the multiple desired objects.

### 6.2 Operation

FIG. 24 illustrates exemplary captured images obtained through time division imaging by the imaging apparatus according to the sixth embodiment.

An upper part of FIG. 24 illustrates an exemplary captured image obtained by performing exposure in accordance with the spectral characteristic of an object 1. A lower part of FIG. 24 illustrates an exemplary captured image obtained by performing exposure in accordance the spectral characteristic of an object 2. As illustrated in the drawing, the imaging apparatus according to the sixth embodiment makes it possible to perform the exposure control in accordance with the spectral characteristics of multiple desired objects in a time division manner by performing time division imaging, and obtain multiple captured images in accordance with the spectral characteristics of the multiple desired objects.

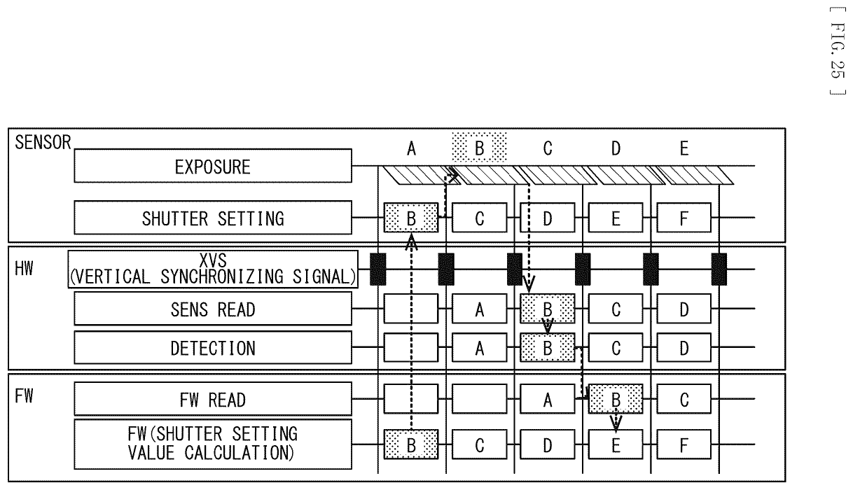

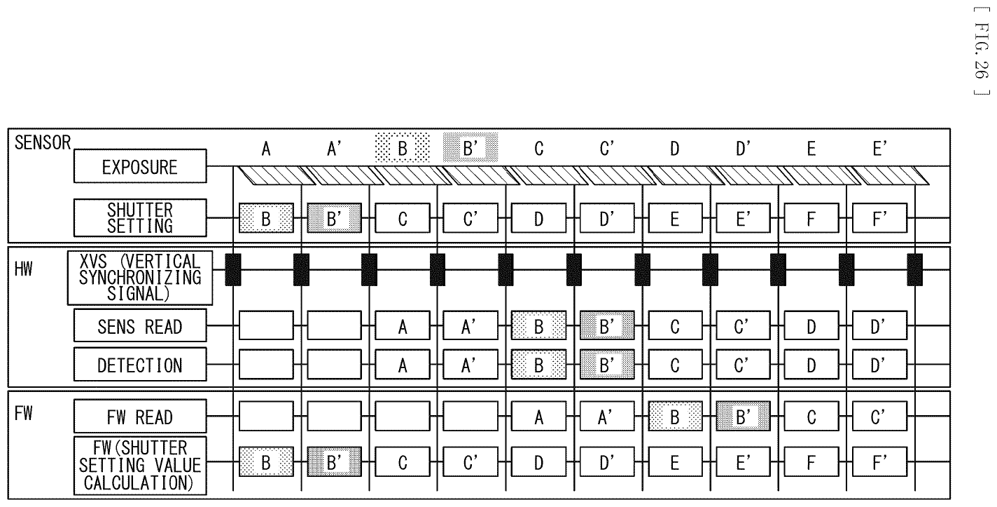

FIG. 25 is a timing chart illustrating an example of an imaging operation involving no time division imaging by the imaging apparatus according to the sixth embodiment. FIG. 26 is a timing chart illustrating an example of an imaging operation involving time division imaging by the imaging apparatus according to the sixth embodiment.

FIGS. 25 and 26 illustrate examples of timing charts in a case where the exposure control is performed only by means of shutters. In FIG. 25, A, B, C, D . . . each correspond to an image captured in a single time of imaging. In the example illustrated in FIG. 26, time division imaging is performed to generate two captured images A and A′ corresponding to a captured image A illustrated in FIG. 25. As illustrated in FIG. 24, for example, the captured images A and A′ are images obtained at different exposure values.

### 6.3 Effect

According to the imaging apparatus of the sixth embodiment described above, it is possible to automatically calculate the exposure amount suitable for each of the multiple objects, and to perform time division imaging for each of the exposure amounts. AE control based on a single wavelength may cause saturation of an image which results in overexposure or black defects; however, performing the time division imaging makes it possible to obtain an image at correct exposure using pixel information on non-saturated wavelengths. Further, performing the time division imaging makes it possible to obtain an image at correct exposure for each of the multiple wavelengths.

### 7. Other Embodiments

The technology of the present disclosure are not limited to the descriptions of the embodiments described above, and various modified embodiments may be made.

For example, the present technology may take the following configurations. According to the present technology having the following configurations, the exposure control is performed on the basis of the detection value in accordance with the spectral characteristic of a desired object. Accordingly, it is possible to perform correct exposure.

(1) An imaging apparatus including:
a multi-spectral sensor that outputs multiple wavelength signals;
a detection circuit that detects a luminance signal in accordance with a spectral characteristic of a desired object on the basis of a detection signal generated using the multiple wavelength signals outputted from the multi-spectral sensor; and a control circuit that performs exposure control in accordance with the spectral characteristic of the desired object on the basis of a detection value of the detection circuit.

(2) The imaging apparatus according to (1) described above, further including
a weighted average circuit that generates, as the detection signal, a weighted average signal calculated from the multiple wavelength signals outputted from the multi-spectral sensor on the basis of a weight coefficient set to each of multiple wavelengths in accordance with the spectral characteristic of the desired object, in which
the detection circuit detects the luminance signal in accordance with the spectral characteristic of the desired object on the basis of the weighted average signal generated by the weighted average circuit.

(3) The imaging apparatus according to (2) described above, further including
a weight designation unit that designates a setting value of the weight coefficient.

(4) The imaging apparatus according to (2) or (3) described above, further including:
an object detection circuit that detects an image of the desired object in a captured image captured by the multi-spectral sensor; and
a weight determination circuit that determines a setting value of the weight coefficient on the basis of the image of the desired object detected by the object detection circuit.

(5) The imaging apparatus according to (4) described above, in which
the multiple wavelength signals include a red (R) signal, a green (G) signal, and a blue (B) signal, and
the object detection circuit detects the image of the desired object by setting an RGB image including the red signal, the green signal, and the blue signal as the captured image.

(6) The imaging apparatus according to (4) described above, in which
the multiple wavelength signals include a red (R) signal, a green (G) signal, and a blue (B) signal, and
the object detection circuit detects the image of the desired object by setting a luminance image in which the red signal, the green signal, and the blue signals are converted into respective luminance signals as the captured image.

(7) The imaging apparatus according to (4) described above, further including
a wavelength designation unit that designates a wavelength to be used by the object detection circuit to detect the image of the desired object.

(8) The imaging apparatus according to any one of (4) to (7) described above, in which
the weight determination circuit determines a value of the weight coefficient corresponding to the image of the desired object detected by the object detection circuit on the basis of weight relating data in which multiple pieces of object data and respective values of the weight coefficients corresponding to the multiple pieces of the object data are associated with each other.

(9) The imaging apparatus according to any one of (4) to (7) described above, in which
the weight determination circuit performs evaluation of luminance of each of multiple wavelengths in the image of the desired object detected by the object detection circuit, and determines a setting value of the weight coefficient corresponding to the image of the desired object detected by the object detection circuit on the basis of a result of the evaluation.

(10) The imaging apparatus according to any one of (2) to (9) described above, further including
a linear matrix processing circuit that conducts linear matrix processing on the multiple wavelength signals outputted from the multi-spectral sensor, in which
the weighted average circuit calculates the weighted average signal from the multiple wavelength signals after the linear matrix processing circuit conducts the linear matrix processing.

(11) The imaging apparatus according to any one of (1) to (10) described above, including
a plurality of the detection circuits, in which
the plurality of the detection circuits detects multiple luminance signals in accordance with respective spectral characteristics of multiple desired objects on the basis of multiple different detection signals generated using the multiple wavelength signals outputted from the multi-spectral sensor, and
the control circuit performs the exposure control in accordance with the spectral characteristics of the multiple desired objects on the basis of multiple detection values detected by the plurality of the detection circuits.

(12) The imaging apparatus according to (11) described above, in which
the control circuit performs the exposure control in accordance with the spectral characteristics of the multiple desired objects on the basis of a result of mixing the multiple detection values.

(13) The imaging apparatus according to (12) described above, further including
a mixing ratio designation unit that designates a mixing ratio between the multiple detection values.

(14) The imaging apparatus according to (11) described above, in which
the control circuit performs the exposure control on the basis of any one of the multiple detection values.

(15) The imaging apparatus according to (1) described above, further including
a ratio determination circuit that identifies the multiple wavelength signals obtained from an imaging region corresponding to the desired object on the basis of a ratio between the multiple wavelength signals calculated for each predetermined region of imaging by the multi-spectral sensor, and generates the identified multiple wavelength signals as the detection signal, in which
the detection circuit detects the luminance signal in accordance with the spectral characteristic of the desired object on the basis of the detection signal generated by the ratio determination circuit.

(16) The imaging apparatus according to (15) described above, in which
the ratio determination circuit identifies the multiple wavelength signals obtained from the imaging region corresponding to the desired object using a determination frame set in a ratio space representing a ratio between multiple predetermined wavelengths.

(17) The imaging apparatus according to (16) described above, in which,
in a case where the ratio determination circuit fails to identify the multiple wavelength signals obtained from the imaging region corresponding to the desired object, the ratio determination circuit generates an average signal of the multiple wavelength signals obtained from all regions of imaging by the multi-spectral sensor as the detection signal.

(18) The imaging apparatus according to (16) or (17) described above, further including
a determination frame designation unit that designates a setting value of the determination frame to be used in the ratio determination circuit.

(19) The imaging apparatus according to any one of (1) to (18) described above, further including:
a weighted average circuit that generates, as the detection signal, a weighted average signal calculated from the multiple wavelength signals outputted from the multi-spectral sensor on the basis of a weight coefficient set to each of multiple wavelengths in accordance with the spectral characteristic of the desired object; and
a ratio determination circuit that identifies the multiple wavelength signals obtained from an imaging region corresponding to the desired object on the basis of a ratio between the multiple wavelength signals calculated for each predetermined region of imaging by the multi-spectral sensor, and generates the identified multiple wavelength signals as the detection signal, in which
the detection circuit detects the luminance signal in accordance with the spectral characteristic of the desired object on the basis of the weighted average signal generated by the weighted average circuit or the detection signal generated by the ratio determination circuit.

(20) The imaging apparatus according to any one of (1) to (19) described above, in which
the multi-spectral sensor performs time division imaging of multiple desired objects,
the detection circuit performs time division detection of multiple luminance signals in accordance with respective spectral characteristics of the multiple desired objects on the basis of multiple different detection signals generated in a time division manner using the multiple wavelength signals outputted from the multi-spectral sensor, and
the control circuit performs the exposure control in accordance with the spectral characteristics of the multiple desired objects in a time division manner on the basis of multiple detection values detected by the detection circuit.

This application claims the benefit of Japanese Priority Patent Application JP2020-213201 filed with the Japan Patent Office on Dec. 23, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An imaging apparatus comprising:
a multi-spectral sensor that outputs multiple wavelength signals;
a detection circuit that detects a luminance signal in accordance with a spectral characteristic of a desired object on a basis of a detection signal generated using the multiple wavelength signals outputted from the multi-spectral sensor; and
a control circuit that performs exposure control in accordance with the spectral characteristic of the desired object on a basis of a detection value of the detection circuit.

2. The imaging apparatus according to claim 1, further comprising
a weighted average circuit that generates, as the detection signal, a weighted average signal calculated from the multiple wavelength signals outputted from the multi-spectral sensor on a basis of a weight coefficient set to each of multiple wavelengths in accordance with the spectral characteristic of the desired object, wherein
the detection circuit detects the luminance signal in accordance with the spectral characteristic of the desired object on a basis of the weighted average signal generated by the weighted average circuit.

3. The imaging apparatus according to claim 2, further comprising
a weight designation unit that designates a setting value of the weight coefficient.

4. The imaging apparatus according to claim 2, further comprising:
an object detection circuit that detects an image of the desired object in a captured image captured by the multi-spectral sensor; and
a weight determination circuit that determines a setting value of the weight coefficient on a basis of the image of the desired object detected by the object detection circuit.

5. The imaging apparatus according to claim 4, wherein
the multiple wavelength signals include a red (R) signal, a green (G) signal, and a blue (B) signal, and
the object detection circuit detects the image of the desired object by setting an RGB image including the red signal, the green signal, and the blue signal as the captured image.

6. The imaging apparatus according to claim 4, wherein
the multiple wavelength signals include a red (R) signal, a green (G) signal, and a blue (B) signal, and
the object detection circuit detects the image of the desired object by setting a luminance image in which the red signal, the green signal, and the blue signals are converted into respective luminance signals as the captured image.

7. The imaging apparatus according to claim 4, further comprising
a wavelength designation unit that designates a wavelength to be used by the object detection circuit to detect the image of the desired object.

8. The imaging apparatus according to claim 4, wherein
the weight determination circuit determines a value of the weight coefficient corresponding to the image of the desired object detected by the object detection circuit on a basis of weight relating data in which multiple pieces of object data and respective values of the weight coefficients corresponding to the multiple pieces of the object data are associated with each other.

9. The imaging apparatus according to claim 4, wherein
the weight determination circuit performs evaluation of luminance of each of multiple wavelengths in the image of the desired object detected by the object detection circuit, and determines a setting value of the weight coefficient corresponding to the image of the desired object detected by the object detection circuit on a basis of a result of the evaluation.

10. The imaging apparatus according to claim 2, further comprising
a linear matrix processing circuit that conducts linear matrix processing on the multiple wavelength signals outputted from the multi-spectral sensor, wherein
the weighted average circuit calculates the weighted average signal from the multiple wavelength signals after the linear matrix processing circuit conducts the linear matrix processing.

11. The imaging apparatus according to claim 1, comprising
a plurality of the detection circuits, wherein
the plurality of the detection circuits detects multiple luminance signals in accordance with respective spectral characteristics of multiple desired objects on a basis of multiple different detection signals generated using the multiple wavelength signals outputted from the multi-spectral sensor, and
the control circuit performs the exposure control in accordance with the spectral characteristics of the multiple desired objects on a basis of multiple detection values detected by the plurality of the detection circuits.

12. The imaging apparatus according to claim 11, wherein
the control circuit performs the exposure control in accordance with the spectral characteristics of the multiple desired objects on a basis of a result of mixing the multiple detection values.

13. The imaging apparatus according to claim 12, further comprising
a mixing ratio designation unit that designates a mixing ratio between the multiple detection values.

14. The imaging apparatus according to claim 11, wherein
the control circuit performs the exposure control on a basis of any one of the multiple detection values.

15. The imaging apparatus according to claim 1, further comprising
a ratio determination circuit that identifies the multiple wavelength signals obtained from an imaging region corresponding to the desired object on a basis of a ratio between the multiple wavelength signals calculated for each predetermined region of imaging by the multi-spectral sensor, and generates the identified multiple wavelength signals as the detection signal, wherein
the detection circuit detects the luminance signal in accordance with the spectral characteristic of the desired object on a basis of the detection signal generated by the ratio determination circuit.

16. The imaging apparatus according to claim 15, wherein
the ratio determination circuit identifies the multiple wavelength signals obtained from the imaging region corresponding to the desired object using a determination frame set in a ratio space representing a ratio between multiple predetermined wavelengths.

17. The imaging apparatus according to claim 16, wherein,
in a case where the ratio determination circuit fails to identify the multiple wavelength signals obtained from the imaging region corresponding to the desired object, the ratio determination circuit generates an average signal of the multiple wavelength signals obtained from all regions of imaging by the multi-spectral sensor as the detection signal.

18. The imaging apparatus according to claim 16, further comprising
a determination frame designation unit that designates a setting value of the determination frame to be used in the ratio determination circuit.

19. The imaging apparatus according to claim 1, further comprising:
a weighted average circuit that generates, as the detection signal, a weighted average signal calculated from the multiple wavelength signals outputted from the multi-spectral sensor on a basis of a weight coefficient set to each of multiple wavelengths in accordance with the spectral characteristic of the desired object; and
a ratio determination circuit that identifies the multiple wavelength signals obtained from an imaging region corresponding to the desired object on a basis of a ratio between the multiple wavelength signals calculated for each predetermined region of imaging by the multi-spectral sensor, and generates the identified multiple wavelength signals as the detection signal, wherein
the detection circuit detects the luminance signal in accordance with the spectral characteristic of the desired object on a basis of the weighted average signal generated by the weighted average circuit or the detection signal generated by the ratio determination circuit.

20. The imaging apparatus according to claim 1, wherein
the multi-spectral sensor performs time division imaging of multiple desired objects,
the detection circuit performs time division detection of multiple luminance signals in accordance with respective spectral characteristics of the multiple desired objects on a basis of multiple different detection signals generated in a time division manner using the multiple wavelength signals outputted from the multi-spectral sensor, and
the control circuit performs the exposure control in accordance with the spectral characteristics of the multiple desired objects in a time division manner on a basis of multiple detection values detected by the detection circuit.
